(19) United States
(12) Patent Application Publication
(10) Pub. No.: US 2010/0233714 A1
(43) Pub. Date: Sep. 16, 2010

(54) MULTISTATE AFFINITY LIGANDS FOR THE SEPARATION AND PURIFICATION OF ANTIBODIES, ANTIBODY FRAGMENTS AND CONJUGATES OF

(76) Inventor: Leslie C. Beadling, South Plainfield, NJ (US)

Correspondence Address: David M. McConoughey, P.O.Box 8477, New York, NY, 10116-8477, US

(21) Appl. No.: 12/734,640

(22) PCT Filed: Nov. 13, 2008
(86) PCT No.: PCT/US2008/012725

§ 371 Date: May 13, 2010

(30) Foreign Application Priority Data
Nov. 13, 2007 (US) 61002827

(51) Int. Cl. C12Q 1/68; G01N 33/53

(52) U.S. Cl. 435/6; 435/7.1

(57) ABSTRACT

Separation of antibodies, antibody fragments, and conjugates thereof using multistate affinity ligands rationally designed and selected to undergo analytically and functionally definable conformational transitions from a first affinity state under a first operator-defined environmental condition to a second affinity state under a second operator-defined environmental condition.

### BACKGROUND OF THE INVENTION

The present invention relates to multistate affinity ligand-based separation and purification of antibodies, antibody fragments and conjugates of antibodies and antibody fragments. Further, the present invention relates to the field of antibody purification. Purification of antibodies from complex mixtures is particularly challenging, as it may be preferable to retrieve all immunoglobulins from a particular sample or, alternatively, to selectively isolate or discriminate immunoglobulins of a particular class, subtype or binding property. Furthermore, established chromatographic methods for antibody purification using immobilized Protein A and Protein G require elution under acidic conditions that have been shown to cause aggregation, precipitation, denaturation and destabilization of antibody molecules. Compositions and methods of making and using multistate affinity ligands are described here for the gentlest possible purification of antibodies and antibody conjugates without exposure to acidic conditions. Purification using multistate affinity ligands is achieved in a manner that allows for separation of all immunoglobulins from a sample or only immunoglobulins of a particular type or species, optionally using ligands that bind to a particular region of the immunoglobulin molecule. These multistate affinity ligands are rationally designed to switch between conformational states that bind and release antibodies and antibody conjugates under conditions that do not perturb antibody or conjugate structure or function. Commercial applications include production and processing of high-value antibodies and antibody conjugates for research, industrial, diagnostic and therapeutic applications.

### SUMMARY OF THE INVENTION

In one embodiment of the present invention, a medium for purifying a target molecule selected from the group consisting of antibodies, antibody fragments and conjugates thereof comprises a nucleotide-containing multistate affinity ligand immobilized on a matrix. The multistate affinity ligand exists in a first state having a defined first affinity for the target molecule in a first buffer and a second state having a defined second affinity for the target molecule in a second buffer wherein the ratio of the defined first affinity to the defined second affinity is at least two.

In another embodiment of the present invention, a preparative device for isolating target molecules from a sample (the target molecules being selected from the group consisting of antibodies, antibody fragments and conjugates thereof) comprises:

a) a nucleotide-containing multistate affinity ligand;

b) means for delivering the sample to the multistate affinity ligand to form a reaction mixture in which the multistate affinity ligand exists in a target-binding state;

c) means for partitioning ligand-target complexes from other substances in the reaction mixture;

d) means for converting the multistate affinity ligand from a target-binding state to a target-nonbinding state; and

e) means for partitioning unbound target molecules from ligand-bound target molecules.

In another embodiment of the present invention, a kit for the purification of an antibody, antibody fragment or conjugate thereof comprises a buffer-responsive multistate affinity ligand, a binding buffer and a releasing buffer. The multistate affinity ligand comprises a nucleotide-containing polymer that switches between an immunoglobulin-binding state in the presence of the binding buffer and an immunoglobulin-nonbinding state in the presence of the releasing buffer.

In another embodiment of the present invention, a system for purifying from a sample a target molecule selected from the group consisting of antibodies, antibody fragments and conjugates thereof comprises:

a) a processing reservoir containing a separation reagent;

b) input means for delivering substances to the processing reservoir;

c) output means for removing substances from the processing reservoir;

d) a first buffer solution; and

e) a second buffer solution;

wherein the separation reagent is a nucleotide-containing multistate affinity ligand that exists in a first state with a relatively high affinity for the target molecule in the presence of the first buffer solution and a second state with a relatively low affinity for the target molecule in the presence of the second buffer solution.

In another embodiment of the present invention, a method of purifying an antigen-binding target molecule from a sample containing the target molecule comprises:

a) contacting the sample with an environmentally-sensitive multistate affinity ligand under a first environmental condition;

b) partitioning the ligand-target complex from nontarget substances in the sample; and

c) releasing the target from the ligand-target complex by exposing the complex to a second environmental condition

wherein

i) the target molecule is selected from the group consisting of antibodies, antibody fragments and conjugates thereof;

ii) the antigen-binding properties of the target molecule remain intact following exposure to the first environmental condition and the second environmental condition; and

iii) the multistate affinity ligand comprises a nucleotide-containing polymer that reversibly partitions between a first state having a first affinity for the target molecule under the first environmental condition and a second state having a second affinity for the target molecule under the second environmental condition.

In another embodiment of the present invention, a method of separating a first molecule comprising an antibody, antibody fragment or conjugate thereof from a second molecule comprises:

a) contacting a sample containing the first molecule and the second molecule with a nucleotide-containing immobilized multistate affinity ligand in a first buffer solution having a composition in which the multistate affinity ligand exists in a first state that specifically binds the first molecule with relatively high affinity;

b) incubating the sample with the immobilized multistate affinity ligand for a sufficient contact time to allow the immobilized multistate affinity ligand to bind the first molecule to form an immobilized ligand-first molecule complex;

c) partitioning the second molecule from the immobilized ligand-first molecule complex;

d) exposing the immobilized ligand-first molecule complex to a second buffer solution having a composition in which the immobilized multistate affinity ligand has a relatively low affinity for the first molecule; and

e) partitioning the first molecule from the immobilized multistate affinity ligand.

In another embodiment of the present invention, a method of making an antibody purification product comprises immobilizing a multistate affinity ligand on an insoluble matrix and packaging the immobilized multistate affinity ligand in a sealed or sealable container. The multistate affinity ligand comprises a nucleotide-containing polymer that specifically binds in a first buffer to an antigen-binding target molecule selected from the group consisting of antibodies, antibody fragments and conjugates thereof to form an immobilized multistate affinity ligand-target complex that dissociates in a second buffer to yield ligand-free target molecule.

In another embodiment of the present invention, a method of separating a first molecule or group of molecules selected from the group consisting of antibodies, antibody fragments and conjugates thereof from a second molecule comprises the steps of:

a) contacting a sample containing the first molecule or group of molecules and the second molecule with a nucleotide-containing multistate affinity ligand immobilized on a solid support immersed in a binding buffer;

b) incubating the sample with the immobilized multistate affinity ligand for a sufficient contact time to allow the immobilized multistate affinity ligand to bind the first molecule or group of molecules to form an immobilized ligand-molecule complex;

c) performing a rinsing step to remove the second molecule;

d) performing at least one elution step to dissociate the first molecule or group of molecules from the ligand of the immobilized ligand-molecule complex; and

e) collecting at least one product of the at least one elution step;

wherein said at least one elution step causes the multistate affinity ligand to shift from a first conformational equilibrium state that favors association of immobilized ligand-molecule complexes to a second conformational equilibrium state that favors dissociation of immobilized ligand-molecule complexes.

In another embodiment of the present invention, a medium for purifying target molecules selected from the group consisting of antibodies, antibody fragments and conjugates thereof comprises a support-bound plurality of ligands, said plurality of ligands including at least one multistate affinity ligand existing in a first state having a defined first affinity for a target molecule in a first buffer and a second state having a defined second affinity for the target molecule in a second buffer wherein the ratio of the defined first affinity to the defined second affinity is at least two.

In another embodiment of the present invention, a method of making an antibody purification product comprises preparing a support-bound plurality of ligands including at least one multistate affinity ligand and packaging the support-bound plurality of ligands in a sealed or sealable container. Said plurality of ligands including at least one multistate affinity ligand comprises a nucleotide-containing polymer that specifically binds in a first buffer to antigen-binding target molecules selected from the group consisting of antibodies, antibody fragments and conjugates thereof to form support-bound multistate affinity ligand-target complexes that dissociate in a second buffer to yield ligand-free target molecules.

### DESCRIPTION OF THE DRAWINGS

FIG. 1. is a chart comparison of triplex multistate affinity ligands with TTTT loops (solid curve) with hexane loops (dotted curve) and with hexaethylene glycol loops (dashed curve). The binding buffer was 20 mM sodium acetate, pH 5.8, plus 1 mM MgCl₂. The elution buffer was 50 mM Tris, pH 8.3 plus 100 mM KCl. At time 0, a sample containing IgG was injected onto the column.

FIG. 2. is a chart comparison of a serum sample run on a Protein A-Sepharose column (a) and on a multistate affinity ligand-Sepharose column (b). For (a) the binding buffer was 20 mM sodium phosphate buffer, pH 7.0, and elution was with a step gradient of 0.1 M citric acid, pH 3.0. For (b) the binding buffer was 20 mM sodium acetate, pH 5.8, plus 1 mM MgCl₂. The elution buffer was 50 mM Tris, pH 8.3 plus 100 mM KCl.

FIG. 3. is a chart in which the dashed curve shows the result of collecting the peak at 10.41 minutes from the multistate affinity ligand column and re-injecting it onto a Protein A column. For comparison, the black curve shows the result of injecting serum directly onto the Protein A column. The binding buffer was 20 mM sodium phosphate buffer, pH 7.0, and elution was with a step gradient of 0.1 M citric acid, pH 3.0.

FIG. 4. is a chart illustrating IgG subtype separations on a Protein A-Sepharose column (a) and on a multistate affinity ligand-Sepharose column (b). For (a) the binding buffer was 20 mM sodium phosphate buffer, pH 7.0, and elution was with a step gradient of 0.1 M citric acid, pH 3.0. For (b) the binding buffer was 20 mM sodium acetate, pH 5.8, plus 1 mM MgCl₂. The elution buffer was 50 mM Tris, pH 8.3 plus 100 mM KCl.

FIG. 5. is a chart illustrating fluorescein-labeled IgG mixed with BSA (solid curves) and with serum (dashed curves). For plot (a) the UV absorbance is monitored at 280 nm. For plot (b) the fluorescence emission is monitored at 528 nm with excitation at 490 nm. The binding buffer was 20 mM sodium acetate, pH 5.8, plus 1 mM MgCl₂. The elution buffer was 50 mM Tris, pH 8.3 plus 100 mM KCl.

FIG. 6. is a chart chromatogram showing the retardation of mouse IgG by the multistate affinity ligand column. The binding buffer was 20 mM sodium acetate, pH 5.8, plus 1 mM MgCl₂. The elution buffer was 50 mM Tris, pH 8.3 plus 100 mM KCl.

### DESCRIPTION OF EMBODIMENTS OF THE INVENTION

The present invention relates to the separation of antibodies, antibody fragments and conjugates thereof using multistate affinity ligands rationally designed and selected to undergo analytically and functionally definable conformational transitions from a first affinity state under a first operator-defined environmental condition to a second affinity state under a second operator-defined environmental condition. The multistate affinity ligands of the invention are tunable in the sense that the structural transition of a multistate affinity ligand from a first conformational state to a second (or third or fourth, etc.) conformational state can modulated in a controlled manner by well-defined changes in environmental conditions. Each conformational state of the multistate affinity ligand has a measurable affinity for a particular target antibody, antibody fragment or conjugate thereof under a particular environmental condition. The difference in affinity of the different conformational states of the multistate affinity ligand for it's the particular target antibody, antibody fragment or conjugate thereof can be used to achieve highly selective separations of populations and subpopulations of target molecules from one another and from nontarget species in specimens, samples and complex mixtures such as biological isolates, culture media, conjugation reactions and the like.

In the present invention, a multistate affinity ligand capable of existing in a first state having a first affinity for a specified antibody and also capable of existing in an alternative second state having a second affinity for said antibody is utilized for purification of specific antibodies, antibody fragments, and conjugates of antibodies and conjugates of antibody fragments. Said multistate affinity ligand may be included in compositions, articles, and methods, including methods, kits, devices, and systems.

### GLOSSARY

The term “affine conformation” means a multiparameter distribution of the atoms conferring affinity on an affinity state, where parameters include, e.g., the spatial positioning of the atoms between and among one another within the conformation. Conformation is determined by structural and/or functional analytical techniques, e.g., by chemical, physical, and/or biological analytical methodologies that identify a particular multiparameter distribution of the atoms. Structural information can be obtained, e.g., by NMR spectroscopy, UV spectroscopy, CD spectroscopy, calorimetry, hydrodynamic, chromatography and electrophoresis. The affinity of a particular conformation can be measured by a variety of techniques for detecting and quantifying molecular interactions, including ligand-receptor binding assays such as filtration assays, immunoassays, polarization assays and the like. Illustrative examples of such chemical methodologies, physical methodologies and chemical and physical methodologies are described.

The term “affine” means having the property of affinity.

The term “affinity” means tendency to associate (“bind”) noncovalently. Noncovalent refers to interactions that do not involve the formation of covalent chemical bonds. Covalent chemical bonds are bonds between atoms that involve the sharing of electron pairs. Covalent bonds are the bonds that hold atoms together as distinct molecules. For example, the hexane molecule comprises 6 carbon atoms and 14 hydrogen atoms that are held together by 5 carbon-carbon covalent bonds and 14 carbon-hydrogen covalent bonds. Noncovalent associations involve associations between or among molecules and may involve a variety of noncovalent forces including hydrogen bonds, Van der Waals forces and electrostatic forces. If a ligand has an affinity for a particular target, that means there is a favorable tendency for the ligand to associate specifically and noncovalently with the target to, form a complex or complexes. The magnitude of the affinity may be defined by an equilibrium constant for complex formation or equilibrium constants for complex formation or by the corresponding free energy of complex formation or the free energies of complex formation. By rigorous thermodynamic convention, affinity is expressed in energy units per mole (e.g. kilojoules/mole or kilocalories/mole) for free energies or in dimensionless units for equilibrium constants. According to this convention, the free energy of a binding event describes the heat given off or taken up during the association of defined molar amounts of ligand and target. The equilibrium constant for a binding event is given in terms of ratios of the relative activities of unbound and bound forms compared to standard state binding conditions and has dimensionless units. In the limit of an infinitely dilute solution, activities are identical to concentration, and measured equilibrium constants are often expressed in terms of concentration ratios (reference: Kenneth Denbigh, The Principles of Chemical Equilibrium, Cambridge University Press, 1973, London, Chapter 10, pp 292-327.) For practical applications in biochemistry and for the purposes of this application, equilibrium constants are defined in terms of ratios of concentrations of ligands, targets and complexes, and activity coefficient corrections are ignored (see reference: Donald J. Winzor and William H. Sawyer, Quantitative Characterization of Ligand Binding, Wiley-Liss, 1995, New York, N.Y., Chapter 1, pp. 1-11). The affinity of a ligand for its target depends on a number of factors, including, e.g., the conformation of the ligand, the conformation of the target and local environmental parameters such as temperature and ionic conditions, which can strongly influence binding without significantly altering conformation.

The term “affinity ligand” means a ligand having at least a first affinity state characterized by a first measurable affinity for a given target molecule (i.e., a cognate antibody, antibody fragment or conjugate of an antibody or antibody fragment) under a first set of conditions and, in the case of a multistate affinity ligand, a second affinity state under a second set of conditions.

The term “antibody” means an antigen- or hapten-binding molecule classified as an immunoglobulin, i.e., an antigen- or hapten-binding immunoglobulin. Immunoglobulins may be derived from any one or more of a variety of species, isotypes and subtypes or any combination thereof. They may also be modified through antibody engineering methods known in the art, including conjugation, humanization, chimerization and the like. Species commonly used in biomedical research include but are not limited to mouse, human, rabbit, goat, rat, cow, cat, chicken, dog, donkey, guinea pig, hamster, horse, sheep and swine. For a given species, there is also a variety of immunoglobulin isotypes, and for each isotype there may be more than one subtype. For humans, the dominant isotypes are IgA, IgD, IgE, IgG, and IgM. Subtypes of IgA include IgA1 and IgA2. Subtypes of IgG include IgG1, IgG2, IgG3 and IgG4.

The term “antibody fragment” means a portion of an antibody obtained, e.g., by reduction, enzyme digestion or translation of an antibody-encoding mRNA sequence. Antibody fragments include, for example, isolated Fab, F(ab′), F(ab′)2 and Fc regions of immunoglobulin molecules.

The term “cognate,” when used in reference to a ligand or target, means the target is specifically recognizable by the ligand or vice versa. A target antigen recognized by an antibody is referred to as the cognate receptor (if the antibody is viewed as the ligand) or, alternatively, the cognate ligand (if the antibody is viewed as the receptor).

The terms “conformationally tunable multistate affinity ligand” and “multistate affinity ligand” as used herein are synonymous.

The term “conjugate,” when used in reference to an antibody or antibody fragment means a covalent or stable noncovalent complex between at least a first molecule and a second molecule, where the first molecule is an antibody or antibody fragment. The second molecule may be any molecule that alters, enhances or complements the properties, function or utility of the antibody or antibody fragment, including, for example and without limitation, a drug, a protein, a lipid, a carbohydrate, a peptide or a signal-generating molecule.

The term “ligand” means a molecule, a molecular complex or a chemically defined part of a molecule or molecular complex that associates specifically and noncovalently with (or “binds to”) a target substance to form a complex involving one or more ligands and one or more target entities. Multistate affinity ligands of the instant invention contain at least one sequence of nucleotides capable of undergoing intramolecular base pairing. The target entity may be, e.g. a molecule, a portion of a molecule, a group of molecules or a macromolecular complex. In some embodiments, the ligand is covalently attached to a support or deposited, localized, concentrated or immobilized on a support or a semisolid medium such as a gel, sol or colloid. In other embodiments, the ligand exists in solution or suspension. In still other embodiments the ligand comprises or attaches to another molecule, optionally a macromolecule, or a bead, particle, carrier, matrix, medium or surface of nano-, micro- or macro-scale.

The term “matrix” is another word for “support.”

The term “multistate” when applied to a ligand means that the ligand exists in a plurality of conformational states under different operator-defined environmental conditions, where a conformational state is defined as the three-dimensional arrangement of atoms within the ligand with respect to each other. Although different affine conformations of a ligand will typically have different binding affinities for target entities, conditions can sometimes be found where different conformations may have the same binding affinity. For example, two different conformations may have different salt dependences on binding affinity, and one or more uniquely defined salt concentrations might therefore be found where both conformations give the same binding affinity. Conformational states may be characterized and defined by, e.g., chemical or spectroscopic methods that are sensitive to the relative positions of atoms within the ligand molecule.

The terms “multistate affinity ligand,” and “conformationally tunable multistate affinity ligand,” which are synonymous with the term “tunable affinity ligand” as used herein, mean a nucleotide-containing ligand that is conformationally tunable through operator-, instrument- or device-defined changes in environmental conditions that yield different conformations of the ligand that are analytically distinguishable from one another and have different affinities for a given target substance. Advantageously, multistate affinity ligands are nucleotide-containing polymers having at least one sequence of nucleotides that participate in intramolecular base pairing to form at least one duplex, triplex, tetraplex, junction, quadruplex or higher order structure under one or more environmental conditions wherein the nucleotide sequence optionally contains a normucleotide spacer or linker group. Essentially, a multistate affinity ligand can exist in at least two different conformational states and can be reversibly changed from one conformational state to another through a defined change in the environment to which the ligand is exposed. The different conformational states can be characterized analytically and/or functionally based, e.g., on spectral signatures, biophysical properties, binding properties and biological activity using methods such as spectroscopic techniques, separation techniques, ligand binding assays, cell-based assays and the like, advantageously including UV spectroscopy, NMR spectroscopy, calorimetry, CD and other methodologies capable of resolving changes in multiparameter distribution of the atoms comprising the multistate affinity ligand under different conditions even in the absence of its cognate target. Thus, the change in affine conformation of the multistate affinity ligand with changes in environmental conditions can be shown to be a property of the ligand itself independent of any conformational change that results from interaction of the ligand with its target. In some embodiments, the multistate affinity ligand is covalently attached to a support or deposited, localized, concentrated or immobilized on a support or a semisolid medium such as a gel, sol or colloid. In other embodiments, the multistate affinity ligand exists in solution or suspension. In still other embodiments the multistate affinity ligand comprises or attaches to another molecule, optionally a macromolecule, or a bead, particle, carrier, matrix, medium or surface of nano-, micro- or macro-scale.

A multistate affinity ligand can exist in a reversibly switchable plurality of conformational states under different operator-, instrument- or device-defined environmental conditions, where a conformational state is defined as the three-dimensional arrangement of atoms within the ligand with respect to each other. Although different affine conformations of a ligand will typically have different binding affinities for target entities, conditions can sometimes be found where different conformations may have the same binding affinity. For example, two different conformations may have different salt dependences on binding affinity, and one or more uniquely defined salt concentrations might therefore be found where both conformations give the same binding affinity. Conformational states may be characterized and defined by chemical or spectroscopic methods that are sensitive to the relative positions of atoms within the. These conformationally tunable multistate affinity ligands are switchable between:

i) at least a first affinity state corresponding to a first affine conformation of atoms and

ii) at least a second affinity state corresponding to a second affine conformation of atoms, the affinity of said first affinity state preferably being different in strength or specificity from said second affinity state wherein at least a portion of atoms comprising said first affine conformation also comprises at least a portion of atoms comprising said second affine conformation. Multistate affinity ligands are designed to partition between or among two or more affine states. An affine state of a multistate affinity ligand is a distinct spatio-temporal conformational state that can be defined analytically, such as by spectroscopic, physical, chemical or other experimental means, and is further characterized under a particular set of environmental conditions by a measurable affinity of the ligand for one or more target molecules. The concept of a multistate affinity ligand is distinct from the concept of an affinity ligand with environment-dependent properties, as the target-binding properties of any affinity ligand depend in some way on environmental conditions (e.g., pH, buffer type, salt concentrations and ionic composition). An affinity ligand with environment-dependent properties would include ligands with a single experimentally distinct conformation whose affinity could be altered by changes in environmental conditions and, as such, would comprise essentially all known ligands. In contrast, a multistate affinity ligand is a ligand having at least two distinct affine conformations that can be reversibly interconverted by operator-dependent changes in environmental conditions and that show distinct binding properties to a given target, including differences in magnitude and differences in dependence on environmental. Multistate affinity ligands of the present invention are designed, selected and developed to have:

i) a plurality of at least two controlled, reversible conformational states;

ii) measurable binding to the target substance in one or more of those conformational states;

iii) conformational transitions that occur under conditions that are nonperturbing to the target substance; and

iv) preferential binding to the target substance in at least one conformational state that has lower and differential binding to nontarget substances, such as contaminants present in the sample or separation mixture containing the target substance. This combination of requirements and features distinguishes multistate affinity ligands capable of existing in multiple, environment-dependent states from other ligands, including those selected by fishing from extremely large pools of molecules.

The term “nucleotide” refers to monomers and sequences comprising natural, synthetic and nonnatural nucleic acid molecules and includes nucleotide bases, analogs, modified bases and other monomers that can be substituted for nucleotide bases during the synthesis of oligonucleotides. Nucleotides include groups of nucleotide monomers comprising oligonucleotides. Any compound containing a heterocyclic compound bound to a phosphorylated sugar by an N-glycosyl link or any monomer capable of complementary base pairing or any polymer capable of hybridizing to nucleic acid molecule is considered a nucleotide as the term is used herein, including nucleotides comprising backbone modifications, abasic regions, spacers, linkers, hinge regions, bridges, space-/charge-modifiers and the like.

The term “nucleotide-containing,” when used in reference to a multistate affinity ligand, means that the multistate affinity ligand contains a sequence of at least three nucleotides, advantageously a sequence capable of intramolecular base pairing.

The term “oligonucleotide” means a naturally occurring, synthetic or nonnaturally occurring polymer of nucleotides, preferably a polymer comprising at least three nucleotides that is capable of intramolecular or intermolecular base pairing and/or participation in formation of duplex, triplex, tetraplex, quadruplex, junction and/or higher order nucleotide structures. Oligonucleotides may be, for example and without limitation, single-stranded, double-stranded, partially single-stranded, partially double-stranded, multi-stranded or partially multi-stranded ribonucleic, deoxyribonucleic, peptide or mixed nucleic acids that may include backbone modifications, heteroduplexes, chimeric structures and the like as well as nucleotides conjugated to one or more normucleotide molecules. Although oligonucleotides of the instant invention typically range in length from about five nucleotides to about 100 nucleotides, they may contain hundreds or even thousands of nucleotides. There is no intrinsic upper limit. Monomeric and dimeric nucleotides such as biological cofactors, messengers and metabolites, e.g., adenosine, AMP, ADP, ATP, cAMP, NAD, NADH, NADH2, FAD, FADH and FADH2, are not considered oligonucleotides as the term is used herein.

The term “polynucleotide” refers to a sequence of nucleotides.

The term “reaction mixture,” when used in reference to a multistate affinity ligand means a solution containing or contacting a multistate affinity ligand wherein the composition of the solution can be varied under operator-, instrument- or device-dependent control.

The term “reagent,” when used in reference to molecular constructs of the instant invention, means a synthetic preparation comprising a multistate affinity ligand.

The term “receptor” means a cognate binding partner of a ligand and is used as an alternative to the term “target” in some contexts, e.g., reference to ligand-receptor interactions.

The term “specific binding” refers to noncovalent interaction between a ligand and a target substance that can be inhibited by structural analogs of the ligand or target substance. The term “specific binding assay” refers to analytical procedures for the detection, monitoring and/or quantification of a target substance in a reaction mixture.

The term “support” means a three-dimensional material, the surface of which may be modified, e.g., by one or more covalent or high affinity noncovalent chemistries or physical or chemical deposition methods designed to attach, immobilize or localize ligands for separations or other applications.

The terms “target,” “target antibody” and “cognate target” mean an antibody, antibody fragment or conjugate thereof that the ligand is intended to bind, as distinct from the more general term used in the art in reference to, e.g., a member of a specific binding pair (e.g., a small molecule, protein, nucleic acid, carbohydrate, glycoprotein, lectin or sugar), a diagnostic analyte (e.g., a drug, hormone, infectious agent or cell surface marker) or a therapeutic target (e.g., a cell, tissue, organ, organism or virus). In the context of the present invention, the term “target” is intended to mean antibodies, antibody fragments, conjugates of antibodies and conjugates of antibody fragments.

The term “target-binding,” when used in reference to the state of a tunable affinity ligand, means a conformational state of the ligand that favors ligand-target complex formation in the presence of a target substance.

The term “target-nonbinding,” when used in reference to the state of a tunable affinity ligand, means a conformational state of the ligand that favors the unbound form of the ligand in the presence of a target substance.

The term “tunable,” when applied to a ligand, means that the conformation of the ligand can be modulated from one analytically or functionally defined state to another in a controlled, operator-, instrument- or device-defined manner by varying the physical or chemical environment of the ligand. Examples of environmental effectors of conformation include temperature, pH, electromagnetic fields (such as electrical fields and magnetic fields), ion concentrations and the concentrations of small molecule effectors. Small molecule effectors include alcohols and DMSO which, by virtue of lowering water activity, will favor transitions toward conformations that result in the net release of thermodynamically “bound” water molecules. Other small molecule effectors include molecules or ions that bind specifically to particular conformations and thereby favor transitions toward those conformations. Examples of such molecules or ions include drugs such as netropsin that bind in the grooves of DNA and intercalators such as ethidium bromide that bind between neighboring base-pairs of duplex DNA. Environmental effectors that modulate the distribution of a tunable ligand among conformational states that differ in target binding affinity will, as a consequence, modulate the affinity of ligand-target binding.

In one embodiment of the present invention, a medium for purifying a target molecule selected from the group consisting of antibodies, antibody fragments and conjugates thereof, comprises a nucleotide-containing multistate affinity ligand immobilized on a matrix. The multistate affinity ligand exists in a first state having a defined first affinity for the target molecule in a first buffer and a second state having a defined second affinity for the target molecule in a second buffer wherein the ratio of the defined first affinity to the defined second affinity is at least two.

In another embodiment of the present invention, a preparative device for isolating target molecules from a sample (the target molecules being selected from the group consisting of antibodies, antibody fragments and conjugates thereof) comprises:

a) a nucleotide-containing multistate affinity ligand;

b) means for delivering the sample to the multistate affinity ligand to form a reaction mixture in which the multistate affinity ligand exists in a target-binding state;

c) means for partitioning ligand-target complexes from other substances in the reaction mixture;

d) means for converting the multistate affinity ligand from a target-binding state to a target-nonbinding state; and

e) means for partitioning unbound target molecules from ligand-bound target molecules.

In another embodiment of the present invention, a kit for the purification of an antibody, antibody fragment or conjugate thereof comprises a buffer-responsive multistate affinity ligand, a binding buffer and a releasing buffer. The multistate affinity ligand comprises a nucleotide-containing polymer that switches between an immunoglobulin-binding state in the presence of the binding buffer and an immunoglobulin-nonbinding state in the presence of the releasing buffer.

In another embodiment of the present invention, a system for purifying from a sample a target molecule selected from the group consisting of antibodies, antibody fragments and conjugates thereof comprises:

a) a processing reservoir containing a separation reagent;

b) input means for delivering substances to the processing reservoir;

c) output means for removing substances from the processing reservoir;

d) a first buffer solution; and

e) a second buffer solution;

wherein the separation reagent is a nucleotide-containing multistate affinity ligand that exists in a first state with a relatively high affinity for the target molecule in the presence of the first buffer solution and a second state with a relatively low affinity for the target molecule in the presence of the second buffer solution.

In another embodiment of the present invention, a method of purifying an antigen-binding target molecule from a sample containing the target molecule comprises:

a) contacting the sample with an environmentally-sensitive multistate affinity ligand under a first environmental condition;

b) partitioning the ligand-target complex from nontarget substances in the sample; and

c) releasing the target from the ligand-target complex by exposing the complex to a second environmental condition

wherein

i) the target molecule is selected from the group consisting of antibodies, antibody fragments and conjugates thereof;

ii) the antigen-binding properties of the target molecule remain intact following exposure to the first environmental condition and the second environmental condition; and

iii) the multistate affinity ligand comprises a nucleotide-containing polymer that reversibly partitions between a first state having a first affinity for the target molecule under the first environmental condition and a second state having a second affinity for the target molecule under the second environmental condition.

In another embodiment of the present invention, a method of separating a first molecule comprising an antibody, antibody fragment or conjugate thereof from a second molecule comprises:

a) contacting a sample containing the first molecule and the second molecule with a nucleotide-containing immobilized multistate affinity ligand in a first buffer solution having a composition in which the multistate affinity ligand exists in a first state that specifically binds the first molecule with relatively high affinity;

b) incubating the sample with the immobilized multistate affinity ligand for a sufficient contact time to allow the immobilized multistate affinity ligand to bind the first molecule to form an immobilized ligand-first molecule complex;

c) partitioning the second molecule from the immobilized ligand-first molecule complex;

d) exposing the immobilized ligand-first molecule complex to a second buffer solution having a composition in which the immobilized multistate affinity ligand has a relatively low affinity for the first molecule; and

e) partitioning the first molecule from the immobilized multistate affinity ligand.

In another embodiment of the present invention, a method of making an antibody purification product comprises immobilizing a multistate affinity ligand on an insoluble matrix and packaging the immobilized multistate affinity ligand in a sealed or sealable container. The multistate affinity ligand comprises a nucleotide-containing polymer that specifically binds in a first buffer to an antigen-binding target molecule selected from the group consisting of antibodies, antibody fragments and conjugates thereof to form an immobilized multistate affinity ligand-target complex that dissociates in a second buffer to yield ligand-free target molecule.

In another embodiment of the present invention, a method of separating a first molecule or group of molecules selected from the group consisting of antibodies, antibody fragments and conjugates thereof from a second molecule comprises the steps of:

a) contacting a sample containing the first molecule or group of molecules and the second molecule with a nucleotide-containing multistate affinity ligand immobilized on a solid support immersed in a binding buffer;

b) incubating the sample with the immobilized multistate affinity ligand for a sufficient contact time to allow the immobilized multistate affinity ligand to bind the first molecule or group of molecules to form an immobilized ligand-molecule complex;

c) performing a rinsing step to remove the second molecule;

d) performing at least one elution step to dissociate the first molecule or group of molecules from the ligand of the immobilized ligand-molecule complex; and

e) collecting at least one product of the at least one elution step;

wherein said at least one elution step causes the multistate affinity ligand to shift from a first conformational equilibrium state that favors association of immobilized ligand-molecule complexes to a second conformational equilibrium state that favors dissociation of immobilized ligand-molecule complexes.

In another embodiment of the present invention, a medium for purifying target molecules selected from the group consisting of antibodies, antibody fragments and conjugates thereof comprises a support-bound plurality of ligands, said plurality of ligands including at least one multistate affinity ligand existing in a first state having a defined first affinity for a target molecule in a first buffer and a second state having a defined second affinity for the target molecule in a second buffer wherein the ratio of the defined first affinity to the defined second affinity is at least two.

In another embodiment of the present invention, a method of making an antibody purification product comprises preparing a support-bound plurality of ligands including at least one multistate affinity ligand and packaging the support-bound plurality of ligands in a sealed or sealable container. Said plurality of ligands including at least one multistate affinity ligand comprises a nucleotide-containing polymer that specifically binds in a first buffer to antigen-binding target molecules selected from the group consisting of antibodies, antibody fragments and conjugates thereof to form support-bound multistate affinity ligand-target complexes that dissociate in a second buffer to yield ligand-free target molecules.

The present invention relates to a new method for separating a target (such as antibodies, antibody fragments, antibody conjugates and/or antibody fragment conjugates, e.g., IgG and/or other related immunoglobulins and immunoglobulin-derived proteins) by using multistate affinity ligands. Multistate affinity ligands are polymeric ligands, synthesized completely or in part by solid phase synthesis methods, and incorporating environmentally sensitive conformational switches. An essential feature of multistate affinity ligands is that under defined conditions the target-binding affinity for binding to a given multistate affinity ligand conformation differs by a measurable degree from binding to another multistate affinity ligand conformation. Multistate affinity ligands are designed to incorporate monomer sequences that have propensities to switch among two or more different conformations, Conformation may be defined by physical measurements that include spectroscopic, hydrodynamic and thermodynamic techniques and by modeling of solution-dependent binding characteristics.

For chromatographic or other separation applications, interactions to surface-attached multistate affinity ligands are modulated by shifting multistate affinity ligand conformational equilibria by using mild changes in solution conditions. The resultant modulation in binding affinity to different targets enhances the ability to obtain high resolution separations.

The method comprises 1) attaching a multistate affinity ligand to a solid support, 2) allowing the surface-attached multistate affinity ligands to interact under binding conditions to a mixture containing one or more distinguishable targets such as antibodies, antibody fragments, antibody conjugates and/or antibody fragment conjugates, e.g., an IgG species, 3) rinsing the solid support under binding conditions to remove unbound or weakly bound contaminants, and 4) eluting from the support using a continuous gradient, or a combination of continuous and step gradients wherein the elution buffer switches the multistate affinity ligand from a conformation or conformations that favor binding to a conformation or conformations that disfavors binding.

Components of the device and method for separating specific target molecules such as antibodies, antibody fragments, antibody conjugates and/or antibody fragment conjugates, e.g., IgG molecules and/or other related immunoglobulins and immunoglobulin-derived proteins, from contaminating material and from other antibody, antibody fragment, antibody conjugate and/or antibody fragment conjugate molecules are briefly described below.

First, a nucleotide-containing oligomeric or polymeric molecule (multistate affinity ligand) is needed that exists in an equilibrium between two or more states. The distribution of the multistate affinity ligand conformations among the accessible equilibrium states is controlled by solution conditions including, but not limited to, the concentrations and nature of salts and other small-molecule effectors, the pH and the temperature. The conformational state of the multistate affinity ligand is defined by physical measurements that are familiar to those skilled in molecular biophysics, polymer chemistry, biochemistry and molecular biology and include, but are not limited to, NMR spectroscopy, UV spectroscopy, CD spectroscopy, calorimetry, hydrodynamic, chromatography and electrophoresis.

Second, a solid support is needed, together with a means for attaching the multistate affinity ligand to the support. For example, the solid support may be chromatographic beads or other media functionalized for attachment, e.g., to primary amines, sulfhydryl groups or biotin labels. The ligand is, in turn, synthesized to have terminal or internal reactive groups to allow functional attachment to the solid support.

Third, buffers and elution conditions are needed in order to 1) facilitate binding and 2) to switch ligand conformation and facilitate release. The minimum requirements are a binding buffer and a release buffer that can be defined in various ratios in continuous or step gradients in order to bind and release target molecules (such as antibodies, antibody fragments, antibody conjugates and/or antibody fragment conjugates, e.g., IgG and/or other related immunoglobulins and immunoglobulin-derived proteins) under controlled conditions.

Finally, additional buffers may be needed to wash the solid support following elution and to regenerate and store the solid support for future separations.

Steps in separating target molecules (such as antibodies, antibody fragments, antibody conjugates and/or antibody fragment conjugates, e.g. IgG molecules and/or other related immunoglobulins and immunoglobulin-derived proteins) from contaminating material and from other antibodies, antibody fragments, antibody conjugates and antibody fragment conjugates, such as, e.g., other IgG molecules. The method for separating target antibodies, antibody fragments, antibody conjugates and/or antibody fragment conjugates (such as, e.g., specific IgG proteins) from other antibodies, antibody fragments, antibody conjugates and/or antibody fragment conjugates (such as, e.g., other IgG proteins and related immunoglobulin-derived proteins) from each other and from undesirable contaminants comprises 1) attaching a nucleotide-containing multistate affinity ligand to a solid support, 2) allowing the surface-attached multistate affinity ligand to interact under binding conditions with a mixture containing one or more distinguishable antibodies, antibody fragments, antibody conjugates and/or antibody fragment conjugates, such as a specific IgG species, 3) rinsing the solid support under binding conditions to remove unbound or weakly bound contaminants, and 4) eluting from the support using a continuous gradient, step gradients or a combination of continuous and step gradients wherein the elution buffer switches the multistate affinity ligand from a conformation or conformations that favors binding to a conformation or conformations that disfavors binding, and 5) re-equilibration of the column with binding buffer. Additional steps useful for reusable separations material comprise 5) rinsing with a wash buffer(s) to clean and de-contaminate the column and 6) rinsing and storing with a storage buffer to maintain the support in functional form. The rinse buffer may be, e.g., a mildly basic solution of sodium hydroxide or a detergent solution to sterilize and remove aggregated proteins. The storage buffer may contain, e.g., low concentrations of toxic or antibiotic material to maintain sterile conditions.

Performance characteristics and advantages of the method over currently used methods: The multistate affinity ligand separations method is superior to existing methods involving Protein A and Protein G in several respects. First, the method is able to purify all known subtypes of, e.g., IgG from species including, e.g., human, mouse, goat and rabbit. For example, the method is able to purify human subtype 3, which is weakly bound to Protein A and cannot be purified using Protein A columns. Second, in contrast to Protein A and G purifications, which involve partial denaturation of target molecules, such as, e.g., IgG, the multistate affinity ligand method is intrinsically mild and nondenaturing. Because of the partial denaturing conditions required for purifications involving Protein A and G, some IgG purifications involving these ligands result in unacceptably large losses of sample IgG and the purified IgG's antigen binding activity. Third, in contrast to a protein ligand such as Protein A or G, multistate affinity ligands are robust ligands which can be subjected to rather harsh washing conditions, including washing with both dilute NaOH and with detergents. Fourth, in contrast to protein ligands such as Protein A or G, which provide only limited ability to fractionate IgG subtypes from each other (and then only from partially purified samples) methods involving multistate affinity ligands can separate different IgG species from each other even from crude IgG-containing mixture. For example, multistate affinity ligand methods allow the separation of various human IgG subtypes from each other as well as resolution of immunoglobulins from different host species, e.g., separation of fetal calf IgG from human IgG. Multistate affinity ligands also allow the separation of IgG based on the number and type of conjugated molecules within an antibody conjugate, e.g., the number and type of fluorescent dyes with which an antibody is labeled.

Media Preparation: Ligand is attached to, e.g., 90 micron particles sold in bulk, 30 micron beads sold in pre-packed columns of various sizes for general laboratory use or 5-10 micron particles comprising high performance media for use with HPLC and proteomics applications. In addition, other possible small preparation formats include, e.g., ligand bound to membrane filters for quick and easy clean-up of culture broths and for concentration of the monoclonal IgG.

Buffers: In addition to regular process buffers for IgG binding and recovery, additional buffers include, e.g., those specifically selected for the removal of contaminating immunoglobulins (e.g., bovine IgG) from target immunoglobulins (e.g., monoclonal IgG produced in cell culture).

Advantages: The multistate affinity ligand-based process results in recovery of activity and the reduction of aggregates caused by elution with denaturing conditions, thereby producing a highly uniform and reproducible IgG product.

The invention is illustrated through the following examples, which describe certain aspects of the invention and are not intended to be limiting:

### EXAMPLES

### Example 1

### Screening of Hairpin and Quadruplex Forming Oligonucleotides by Filtration of Sepharose-Bound IgG

78 different hairpin- and quadruplex-forming oligonucleotides were synthesized and aliquoted into a 96-well microplate. Samples of each of these oligonucleotides were screened for IgG binding in 96-well silent screen plates with 3.0 um pore size Loprodyne membrane. For each of the oligonucleotides, two sets of individual aliquots (100 uL in volume) of equimolar concentration were prepared for screening. A 10 uL suspension of mixed human IgG bound to Sepharose beads was added to one of the individual aliquots, incubated for 20 minutes and filtered through the screen. Individual aliquots were filtered through the membrane under vacuum and collected on 96-well UV-plates. The IgG-derivatized Sepharose beads were retained on the plate along with the bound DNA, and the unbound oligonucleotide passed through the screen. Both plates were read in a plate reader for the difference in optical density (OD) reading, which served as an indicator of binding. The experiment was repeated with various buffer and salt conditions. Two significant hits, at well positions C7 and H2, were identified based on interaction with the IgG-Sepharose beads. Eight other hits of lesser binding activity were also identified. Of the lead sequences, d(TTTTCGCGCGTTTCCGCGCGAA) was designed to form a hairpin, and d(TTTTGGTTGGGGTGGTTGG) was designed to form a quadruplex. Among the other eight oligomers, six of them were hairpins, and the rest were potential quadruplexes.

### Example 2

### Reverse-Screen Experiment Identifies a Lead Compound

C7, H2 and the control oligomer d(TGTGTGTGTGTGTGT) were synthesized with terminal 5′aminohexyl groups and were used to derivatize activated Sepharose beads. The retention of IgG and the IgG fragment Fab′2 proteins on immobilized C7, H2, (TG)7T and ethanolamine Sepharose beads was determined on 96-well filter plates (3.0 micron pore size) in a buffer containing 100 mM TEAA, 20 mM Mg²⁺, pH 7. The objectives were a) to distinguish between normal protein retention on the screen, Sepharose, immobilized regular oligonucleotides, and the immobilized multistate affinity ligands, and b) to validate the previous plate assays, between immobilized IgG, and free multistate affinity ligands. For each concentration of protein, two sets of individual aliquots (150 uL in volume) were prepared for screening. Six different stock solutions of each protein were prepared for this assay. For the standard curve, each concentration of the protein was used in triplicate, and directly added to the 96-well UV plate. A 10 uL suspension of DNA bound to Sepharose beads was added to one of the individual aliquots, incubated for 20 minutes and filtered through the screen. Each set of the individual aliquots was filtered through the membrane under vacuum and collected on 96-well UV-plates. The protein bound on the beads was retained on the plate, and unbound protein passed through the screen. In order to determine protein concentrations, freshly prepared BCA reagent was added to each well (150 uL), incubated for 2 hrs at 35 C, and the absorbance was measured at 562 nm. Standard curves of different concentrations of protein in BCA reagent were determined for comparison.

Upon analysis of the filtrate (protein concentration) in each well, the degree of retention was as follows H2>C7>>TG repeat>capped ethanolamine (Sepharose used as blank screen). Hence both the above multistate affinity ligands had greater affinity for the proteins than other oligonucleotides and blank beads, which validated our above results.

### Example 3

### Biophysical Signatures of Lead Compound Suggest the Possible Role of a Triple-helical Structure

The CD spectra of H2 revealed the presence of a secondary structure for H2 in the presence of magnesium ion with a positive peak at 258, and a smaller positive peak at 295. Upon Fab′2 binding, the peak at 295 grew bigger with time. Titration of H2 into IgG and Fab′2 had a larger effect on the intrinsic fluorescence of the proteins in the presence of Mg²⁺ than in the absence. Since under the conditions of these experiments, Mg²⁺ is expected to destabilize quadruplexes, the Mg²⁺ effect suggested a potential alternative structure, e.g., a triplex structure. Triplexes are well-known to be stabilized by the presence of Mg²⁺.

Experimental Details For the CD experiments, the standard solution conditions were 20 mM PIPES, 2 mM Mg²⁺, 20 mM K⁺, pH 6.1. The data were acquired using an Aviv model 62DS spectropolarimeter (AVIV Instruments, Lakewood, N.J.) using 1.0 mm strain-free Quartz cuvettes. Samples were thermostatically controlled at 25 C and contained at least 20 uM multistate affinity ligand. Samples were scanned from 340 nm to 200 nm at 0.2 nm intervals, using a 20 sec averaging time.

### Example 4

### A Triplex 31Mer Shows Favorable Binding Properties

The triplex 31mer 5′-CCTCTTC-TTTTT-CTTCTCC-TTTTT-GGAGAAG-3′ was synthesized and tested for binding to IgG and to IgG fragments. As observed using fluorescence spectroscopy, when the 31mer was titrated in IgG, the intrinsic fluorescence quenched upon multistate affinity ligand binding. In fact, the 31mer quenched the intensity more and increased the melting temperature by 3 C over H2 at pH 6.0. The UV melting data revealed that at lower pH in the presence of Mg²⁺, the triplex was predominant. Circular, dichroism (CD) measurements verified triplex formation and the interaction with IgG. The signature trough around 216 nm indicated the formation of triplex.

### Example 5

### Behavior of Different Multistate Affinity Ligands with Respect to IgG Binding as Measured by Ultrafiltration

Eleven oligonucleotides were designed and synthesized to represent molecules that can potentially undergo conformational transitions involving quadruplexes, triplexes and three-way junction structures. Members of this primary set of oligonucleotides are listed and described in Table 1.

TABLE 1
Eleven molecules chosen for initial screening experiments.

| | | potential | |
|---|---|---|---|
| Name | Sequence | conformations | Major effectors |
| RAD1 | CCT CTT C(HEG)CT TCT CC(HEG)G GAG AAG | YYR triplex | Mg²⁺, pH, NaCl |
| | | HEG linkers | |
| RAD2 | CCT CTT CTT TTT CTT CTC CTT TTT GGA GAA G | YYR triplex | Mg²⁺, pH, NaCl |
| RAD9 | CTC TCT CTT TTT CTC TCT CTT TTT GAG AGA G | YYR triplex | Mg²⁺, pH, NaCl |
| RAD7 | GAG AGA GTT TTT GAG AGA GTT TTT CTC TCT C | RRY triplex | Mg²⁺, NaCl |
| RAD3 | TGG TTG GTT TTT GGA AGG ATT TTT TCC TTC C | RRY triplex/ | Mg²⁺, KCl, LiCl |
| | | quadruplex | |
| RAD6 | GGA AAG GTT TTT GGA AAG GTT TTT CCT TTC C | RRY triplex/ | Mg²⁺, KCl, LiCl |
| | | quadruplex | |
| RAD10 | TGG GCC GGT AAC GGG TTA CCG TAA GGT CCC | 3 way junction/ | Mg²⁺, KCl, LiCl |
| | | quadruplex | |
| RAD11 | TGG GCC GGT AAC GGA TTA CCG TAA GGT CCC | 3 way junction/ | Mg²⁺, KCl, LiCl |
| | | quadruplex | |
| RAD4 | CCC TCC CTG GGC TTT TTT TGA TTT TTC TTA A | CONTROL | |
| RAD5 | GAG TGA GTC TCA GTT AGT TTC GAT TGA TTC T | CONTROL | |
| RAD8 | TGG AGT CTG CGC GAG TCA GCG CTC AAG ATC | CONTROL | |

The molecules shown in Table 1 were screened for mixed human IgG binding on 96-well ultrafiltration plates from Millipore (MSNUO3010), using a vacuum device to draw samples through the membrane. IgG samples (ChromPure Human IgG) were obtained from Jackson ImmunoResearch Laboratories (West Grove, Pa.). These ultrafiltration plates allow multistate affinity ligands to pass through with a retention of less than 20%, but prevent IgG from passing through with retention of greater than 10%. These retentions were determined experimentally, under the buffer conditions of our measurements. The experimental protocol is as follows. A 200 microliter solution containing buffer, IgG and multistate affinity ligand were mixed, and filtered. IgG concentrations ranged from 0.1 μM to 2 μM, and multistate affinity ligand concentrations ranged from 20 nM to 100 nM. Standard solutions of multistate affinity ligand alone were also filtered, covering the experimental range of 20 nM to 100 nM. 50 microliter aliquots of the eluate from each filtration were added to three separate 150 μl test solutions containing 100 nM YOYO-1 dye, 150 mM NaCl, 15 mM sodium citrate, 10 mM CHAPS, pH=7.0, and 100 nM of either YOYO-1 dye or BOBO-3 dye (Invitrogen, Carlsbad, Calif.). The fluorescence intensities of each test solution were measured in a 96-well plate format, using a FarCyte plate reader (Amersham Pharmacia, Piscataway, N.J.) with filters at 485 nm for excitation and 535 nm for emission for the YOYO-1 measurements and with filters at 544 nm and 595 nm for the BOBO-3 measurements. The intensity readings from filtrates of the standard multistate affinity ligand concentrations were plotted vs. multistate affinity ligand concentration, and data points were fitted with a straight line. The multistate affinity ligand intensity from filtrates in the presence of IgG were compared to these standard curves and used to determine the amount of free IgG in these filtrates. By subtracting this number from the total concentration of IgG in the initial solution, the amount of oligonucleotide bound to IgG was obtained. From these measurements, the association equilibrium constant for oligonucleotide binding was obtained using the equation Kₐ=[PD]/[D]*[P], where [PD] is the concentration of bound oligonucleotide, [D] is the concentration of free oligonucleotide and [P] is the concentration of free IgG. Some results of the ultrafiltration determinations of multistate affinity ligand binding to mixed human IgG (ChromPure, Jackson ImmunoResearch Laboratories, West Grove, Pa.) are shown in Table 2 under the defined solution conditions given in the table. The results in this table were obtained using BOBO-3 dye. Substantially similar results were obtained with YOYO-1 dye.

TABLE 2
Screening results of eleven conformationally diverse multistate
affinity ligands for binding to IgG, sorted by binding at pH 6.¹

| | | % | % | | |
|---|---|---|---|---|---|
| | | bound | bound | logKa | logKa |
| Description | name | pH 6 | pH 7 | pH 6 | pH 7 |
| YYR triplex | RAD 9 | 60 | 35 | 7.02 | 6.51 |
| YYR triplex HEG linkers | RAD 1 | 59 | 55 | 7.01 | 6.94 |
| YYR triplex | RAD 2 | 57 | 48 | 6.96 | 6.78 |
| CONTROL | RAD 4 | 53 | 38 | 6.89 | 6.58 |
| RRY triplex | RAD 7 | 52 | 33 | 6.86 | 6.47 |
| RRY triplex/quadruplex | RAD 6 | 51 | 35 | 6.84 | 6.51 |
| CONTROL | RAD 5 | 50 | 34 | 6.82 | 6.49 |
| RRY triplex/quadruplex | RAD 3 | 44 | 38 | 6.71 | 6.58 |
| 3 way junction/ | RAD 11 | 35 | 33 | 6.51 | 6.47 |
| quadruplex | | | | | |
| 3 way junction/ | RAD 10 | 26 | 27 | 6.31 | 6.32 |
| quadruplex | | | | | |
| CONTROL | RAD 8 | 20 | 16 | 6.13 | 6.01 |

¹Solution conditions: 0.15 M NaCl, 0.015 M sodium citrate, 1 mM MgCl₂. The multistate affinity ligand concentration was 100 nM and the IgG concentration was 200 nM.

### Example 6

### Triple-Helical Multistate Affinity Ligands as Tunable Ligands for Chromatographic Separation of Immunoglobulin G Antibodies: Effect of Loop Composition on Retention Times

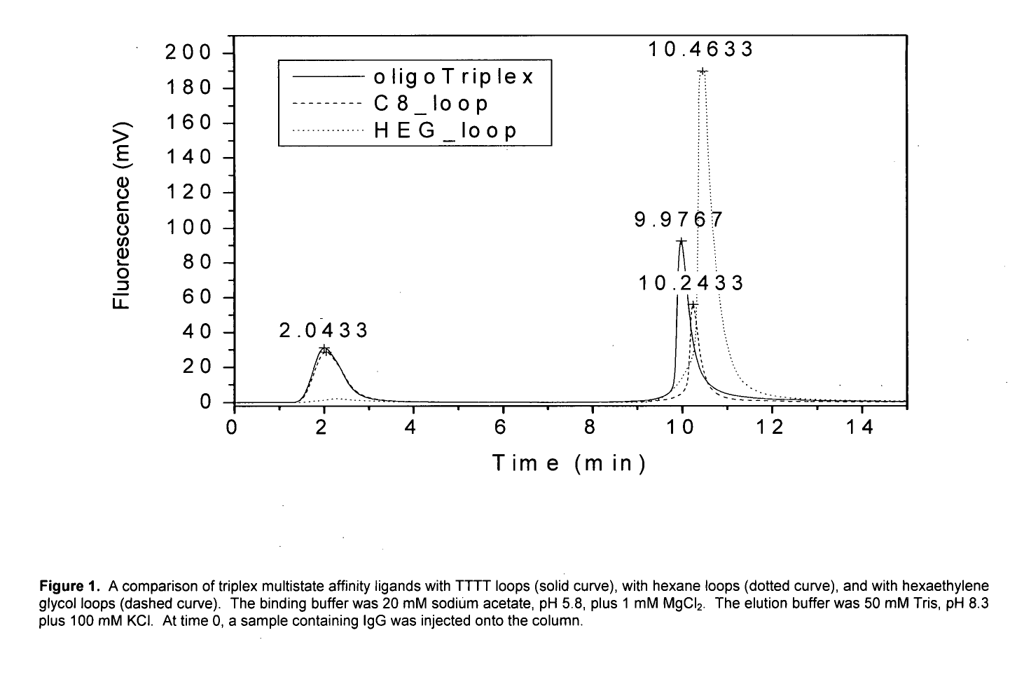

The triple-helix forming multistate affinity ligand, RAD2 (see Tables 1 and 2) was synthesized with an aminohexane linker (C6Am) on the 5′ end to give 5′-C6Am-CCTCTTCTTTTTCTTCTCCTTTTTGGAGAAG-3′. This oligonucleotide was attached to Sepharose beads in a chromatography column using standard coupling chemistries. Briefly, the C6-amino terminal of the oligonucleotide was coupled with the n-hydroxy succinamide moiety of the column. The free NHS-activated groups were capped using ethanolamine. For comparison, variants of this multistate affinity ligand containing loop regions with hexaethylene glycol linkers and hexane linkers were also attached to Sepharose beads in a similar manner. These three chromatographic columns were compared for retention efficacy under gradient elution conditions that were designed to favor the tightly binding conformation at the beginning of the experiment and to favor the weakly binding conformation at the end of the chromatographic elution. Under these gradient conditions, the multistate affinity ligand variant with the hexaethylene glycol linkers, CCTCTTC(HEG)CT TCTCC(HEG)GGAGAAG, shows enhanced retention compared to the other variants (see FIG. 1). In this experiment, at time 0 a sample of fluorescein labeled human IgG (Jackson ImmunoResearch Laboratories, West Grove, Pa.) was injected onto the column, and fluorescence was monitored as a function of time using excitation at 490 nm and emission at 528 nm.

### Example 7

### Triple-Helical Multistate Affinity Ligands as Tunable Ligands for Chromatographic Separation of Immunoglobulin G Antibodies: Separation of IgG from Complex Samples

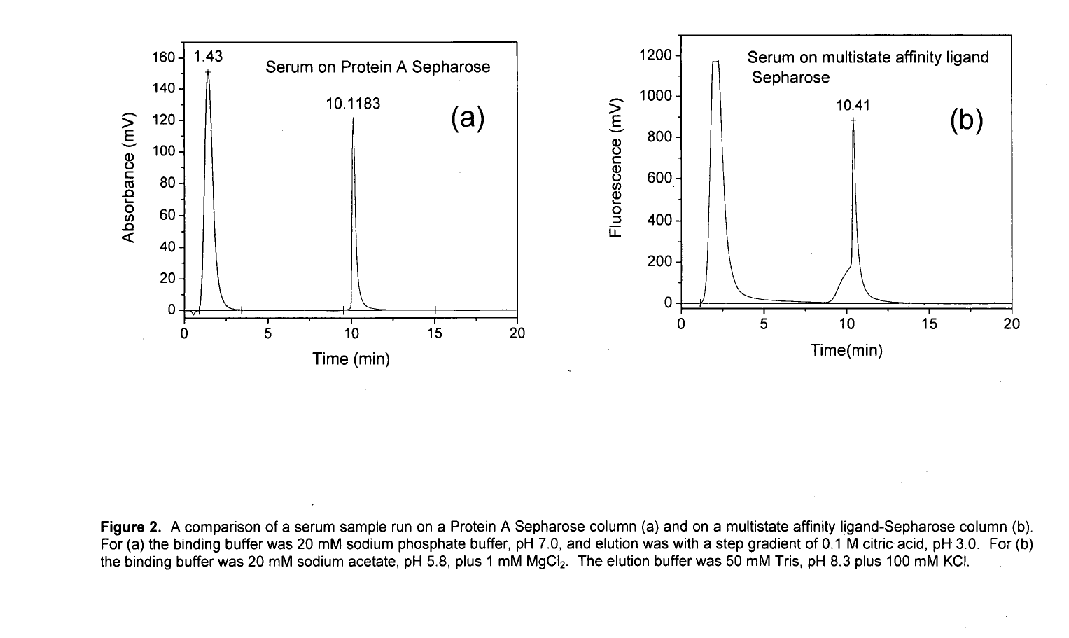

The column prepared from the multistate affinity ligand variant with the hexaethylene glycol linkers, CCTCTTC(HEG)CTTCTCC(HEG)GGAGAAG, was further examined for its ability to separate IgG from complex biological samples, and the results were compared to separations of IgG from these samples performed using a Protein A-Sepharose column. The results of such a comparison are shown in FIG. 2, where the separation results for a serum sample run over a Protein A-Sepharose column is compared to those on our lead multistate affinity ligand-Sepharose column. The peak at 10.1 minutes collected from the Protein A-Sepharose column and the peak at 10.42 minutes collected from the multistate affinity ligand column were each electrophoresed over a 4-12% polyacrylamide gel using 1×SDS buffer and compared with IgG standards and molecular weight markers. After silver staining, only two bands were seen from each sample, one at about 50 kD, and another about 25 kD, as expected after breaking of all the disulfide linkage. The two bands from the multistate affinity ligand-purified sample corresponded with the two bands from the Protein A-purified sample and with the two bands of the IgG standard. The conclusion is that the purity of the multistate affinity ligand purified serum sample is indistinguishable from the purity of the Protein A purified sample as judged by SDS gel electrophoresis.

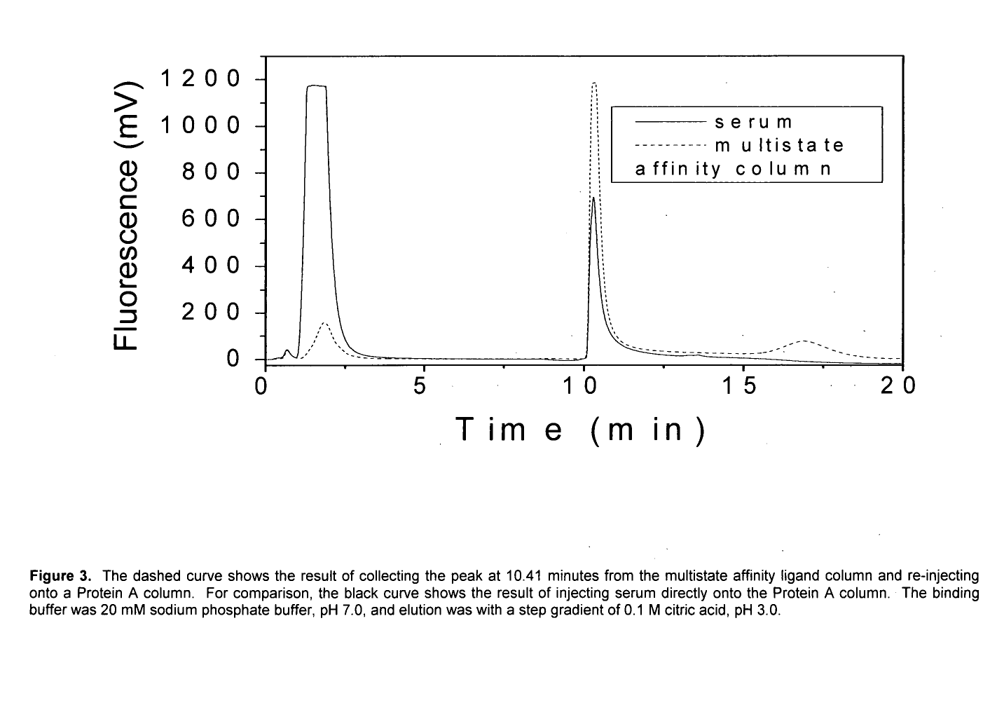

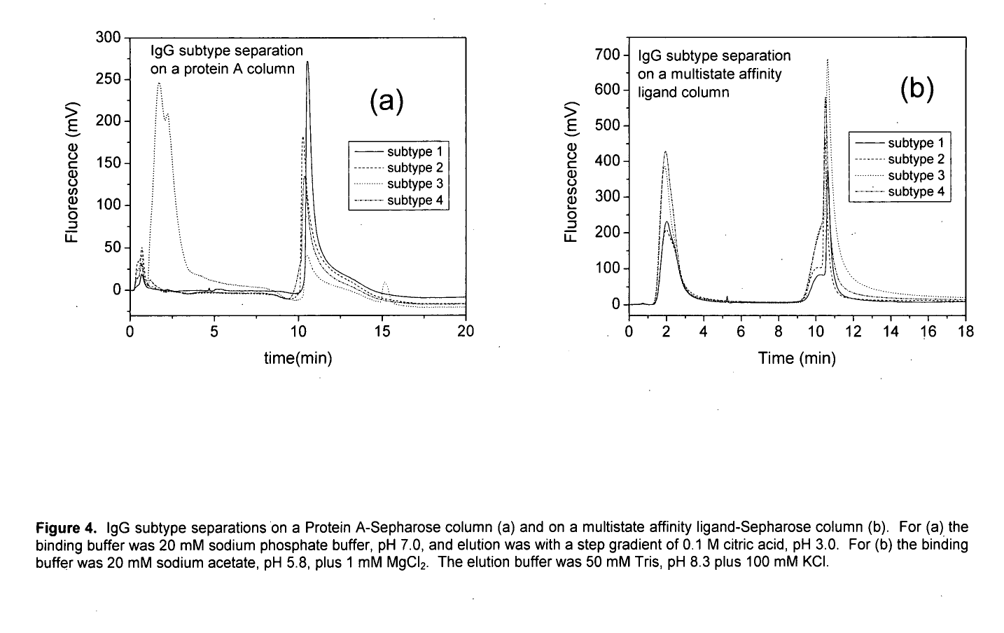

Also, as shown in FIG. 3, when material collected from the multistate affinity ligand peak is re-injected onto a Protein A-Sepharose column, most of the peak is retained at the position characteristic of IgG. The small amount of protein that comes through in the void volume appears to correspond to IgG subtype 3. In contrast to the Protein A column, our multistate affinity ligand column retains all IgG subtypes with comparable efficacy (see FIG. 4). Indeed, as seen in FIG. 4, the slightly longer retention time that is observed for the IgG3 subtype compared to the other subtypes suggests a modestly higher affinity of the multistate affinity ligand column for the IgG3 subtype compared to the other subtypes. Application of a shallower gradient represents an attractive approach to separating some or all of the IgG subtypes from each other.

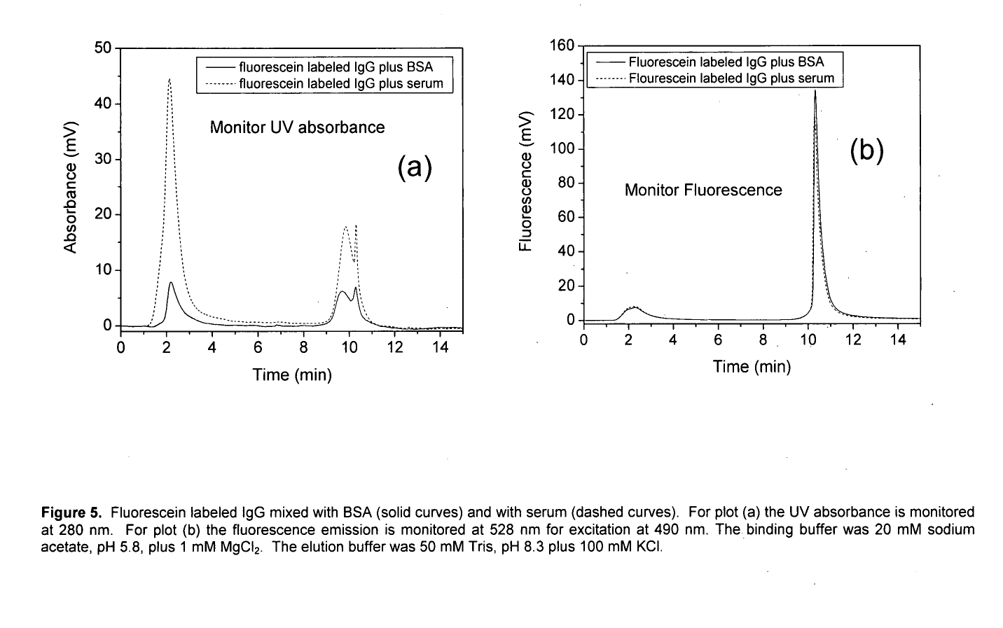

A further demonstration of the ability of our multistate affinity ligand column to bind specifically to IgG is shown in FIG. 5, which shows the results of separations of fluorescein labeled IgG from 1) a sample containing labeled IgG plus BSA and 2) from a serum sample that was doped with fluorescein-labeled IgG. Interestingly, a comparison of the UV and fluorescence signals of the serum sample (which contains unlabeled IgG from the blood) suggests a partial resolution of labeled and unlabeled IgG, again with the application of a step gradient. This observation suggests that multistate affinity ligand technology can separate closely related proteins that differ only in the extent of fluorescent labeling.

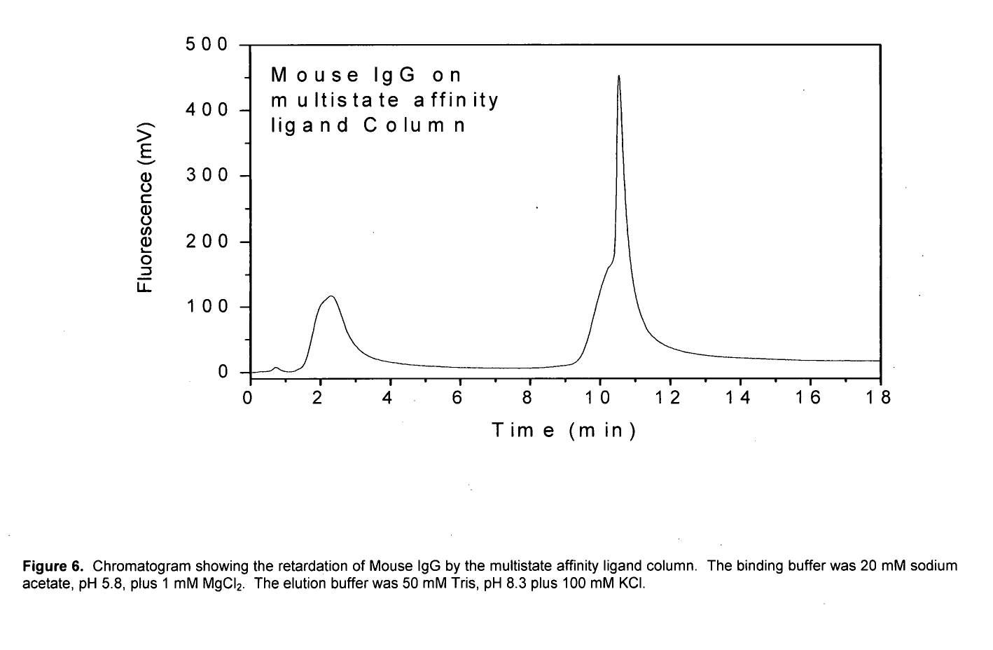

The ability of our lead compound to separate human from mouse IgG has been examined. As shown in FIG. 6, our lead multistate affinity ligand column does bind tightly to mouse IgG, as it does to human IgG. Based on this observation, a process of multistate affinity ligand and gradient optimization is being developed for the separation of human from mouse antibodies.

### Example 8

### Multistate Affinity Ligand-Antibody Interaction Screening Assay

The purpose of work described in this example was to devise a rapid method to screen multistate affinity ligand interactions with target antibodies and antibody conjugates in a way that predicts the performance of multistate affinity ligands as chromatographic ligands.

Basic Methodology:

Individual multistate affinity ligands were mixed with the target antibodies or antibody conjugates in various solution environments. After a short incubation, the mixture was separated by ultrafiltration through a UF well plate that retains the target and the target-bound multistate affinity ligand. The filtrate containing the unbound multistate affinity ligand was collected and the multistate affinity ligand quantified by the use of a fluorescent dye which, when it interacts with the multistate affinity ligand, shows a large increase in fluorescence quantum yield. The fluorescence intensity of the multistate affinity ligand filtrate was measured by a fluorescence plate reader and quantified using a standard curve of fluorescence intensity related to multistate affinity ligand concentration. Filtrate with low fluorescence intensity indicates multistate affinity ligand binding to the target and, thus, potential for use as a chromatographic affinity ligand for the target antibody or antibody conjugate.

Background

The selection of the proper ultrafiltration well plate for screening was critical for the assay effectiveness. The UF plate must effectively separate the larger target and target-bound multistate affinity ligand from the free multistate affinity ligand. Also the UF membrane must exhibit high passage and low binding of the free multistate affinity ligand for proper quantification. Finally the vacuum filtration device must exhibit little cross contamination between filtrate wells. The Millipore (Billerica, Mass.) MultiScreen HITS PCR 96-Well Plate system best met these requirements. The UF well plate membrane retains protein to >90% and allows >98% recovery of unbound multistate affinity ligand in the filtrate. The design of the Millipore MSVM HITS vacuum manifold reduces cross contamination for filtered wells.

Selection of the best fluorescent dye for quantification of the multistate affinity ligand was a difficult task. The dye must show a large (2 orders of magnitude) increase in fluorescence upon interaction to the multistate affinity ligand to reduce background allowing detection low quantities (nanomolar). The fluorescence intensity should be linear over several orders of magnitude. Also, it is desirable to have the fluorescence intensity somewhat uniform independent of the composition of the multistate affinity ligand. The Molecular Probes (Eugene, Oreg.) dye Picogreen was the best compromise having the desired features of a detection fluor for multistate affinity ligand quantification. It was sensitive and showed linearity in the desired concentration range. However, Picogreen required individual calibration curves be established for individual multistate affinity ligands. It also showed a tendency to bind to the assay plate which had to be reduced by the addition of the detergent CHAPS to the fluorescence assay wells.

Experimental Procedure:

The fluorescence intensity versus multistate affinity ligand concentration standard curves were prepared for each multistate affinity ligand for every assay. Curves were prepared by filtering 200 microliters of a 100 nM, 50 nM and 20 nM multistate affinity ligand solution through the UF well plate, collecting the filtrate and making measurements in triplicate by taking 50 microliters of filtrate and mixing with 100 microliters of 0.1 micromolar Picogreen, 10 mM CHAPS solution. Measurements were made in a FARCyte fluorescence microplate reader (Amersham Pharmacia, Piscataway, N.J.) using a 485/20 nm excitation filter and a 535/25 emission filter.

A typical multistate affinity ligand-antibody interaction assay involved making a 200 microliter mixture containing multistate affinity ligand at a concentration of 100 nM and target antibody at a concentration of 200 nM, incubating at RT for 30 minutes and filtering through the UF well plate under 25 inches of Hg vacuum pressure. The filtrate was collected and triplicate assays for multistate affinity ligand in the filtrate were made with the addition of Picogreen in CHAPS as described above. The amount of free multistate affinity ligand in the filtrate was quantified from the standard curves prepared from the same filtration.

### Example 9

### Behavior of Different Multistate Affinity Ligands with Respect to Immunoglobulin Binding as Measured by Ultrafiltration Using a Picogreen Dye-Based Assay

Nineteen oligonucleotides were designed and synthesized to represent molecules that can potentially undergo conformational transitions involving a variety of forms. These oligonucleotides are listed and described in Table 3. The molecules were screened for immunoglobulin binding on MSNUO3010 96-well ultrafiltration plates from Millipore (Billerica, Mass.) using a vacuum device to draw samples through the membrane. These ultrafiltration plates allow multistate affinity ligands to pass through with a retention of less than 20%, but prevent antibodies and antibody fragments from passing through with retention of greater than 10%. These retentions were determined experimentally under the buffer conditions of our measurements. Polyclonal human and mouse IgG samples were obtained from Jackson ImmunoResearch Laboratories (West Grove, Pa.). Monoclonal IgM, IgA and IgG subtypes were obtained from Calbiochem (a subsidiary of EMD, Biosciences, Gibbstown, N.J.). The Molecular Probes (Eugene, Oreg.) dye Picogreen was used as a detection fluor for oligonucleotide quantification. It was sensitive and showed linearity in the desired concentration range. However, Picogreen required individual calibration curves be established for individual oligonucleotides. It also showed a tendency to bind to the assay plate, which nonspecific binding had to be reduced by the addition of the detergent CHAPS to the fluorescence assay wells. The experimental protocol was as follows.

The fluorescence intensity versus multistate affinity ligand concentration standard curves were prepared for each multistate affinity ligand for every assay. Curves were prepared by filtering 200 microliters of a 100 nM, 50 nM, and 20 nM multistate affinity ligand solution through the UF 96-well plate, collecting the filtrate and making measurements in triplicate by taking 50 microliters of filtrate and mixing with 100 microliters of 0.1 micromolar Picogreen, 10 mM CHAPS solution. Measurements were made in a FARCyte fluorescence microplate reader (Amersham Pharmacia, Piscataway, N.J.) using a 485/20 nm excitation filter and a 535/25 emission filter.

A typical multistate affinity ligand-protein interaction assay involved making a 200 microliter mixture containing multistate affinity ligand at a concentration of 100 nM and protein at a concentration of 200 nM, incubating at RT for 30 min., and filtering through the UF well plate under 25 inches of Hg vacuum pressure. The filtrate was collected and triplicate assays for multistate affinity ligand in the filtrate were made with the addition of Picogreen in CHAPS as described above. The concentration of free multistate affinity ligand in the filtrate (LF) was quantified from the standard curves prepared from the same filtration. The concentration of bound multistate affinity ligand (LB) was determined by subtracting the free multistate affinity ligand concentration from the total multistate affinity ligand concentration. Since for the curves presented here the total multistate affinity ligand concentration was 100 nM, the bound concentration (LB) expressed in nanomoles per liter (nM) was calculated as: (LB)=100−(LF). Equilibrium constants were calculated from a single site model:

$${K}_{a} = \frac{( LB )}{( LF ) ( P )} .$$

where (LB) is the concentration of bound multistate affinity ligand, (LF) is the concentration of free multistate affinity ligand and (P) is the concentration of free (unbound) IgG.

Experiments were performed at pH 5, 6, 7 and 8 in various dilutions of buffer containing 150 mM NaCl and 15 mM sodium citrate (“SSC solution”). In undiluted SSC solution, the total concentration of Na⁺ was 165 mM. At two-, four- and ten-fold dilutions of SSC (0.5 SSC, 0.25 SSC and 0.1 SSC, respectively), the sodium ion concentration was as follows:

0.5 SSC (two-fold dilution): 82.5 mM Na⁺

0.25 SSC (four-fold dilution): 41.25 mM Na⁺

0.1 SSC (ten-fold dilution): 16.5 mM Na⁺

Standard curves were measured for human polyclonal IgG binding to the oligonucleotides shown in Table 3. These curves were linear to a good approximation, and were thus used to determine unknown concentrations of oligonucleotide from the filtrate.

TABLE 3
Oligonucleotides used in this study (members of the
primary set of 11 are underlined).

| | | potential | |
|---|---|---|---|
| Name | Sequence | conformations | effectors |
| RAD1 | CCT CTT C/iSp18/CT TCT CC/iSp18/G GAG AAG | YYR triplex | Mg²⁺, pH, NaCl |
| | | HEG linkers | |
| RAD2 | CCT CTT CTT TTT CTT CTC CTT TTT GGA GAA G | YYR triplex | Mg²⁺, pH, NaCl |
| RAD3 | TGG TTG GTT TTT GGA AGG ATT TTT TCC TTC C | RRY triplex/ | Mg²⁺, KCl, LiCl |
| | | quadruplex | |
| RAD4 | CCC TCC CTG GGC TTT TTT TGA TTT TTC TTA A | CONTROL | |
| RAD5 | GAG TGA GTC TCA GTT AGT TTC GAT TGA TTC T | CONTROL | |
| RAD6 | GGA AAG GTT TTT GGA AAG GTT TTT CCT TTC C | RRY triplex/ | Mg²⁺, KCl, LiCl |
| | | quadruplex | |
| RAD7 | GAG AGA GTT TTT GAG AGA GTT TTT CTC TCT C | RRY triplex | Mg²⁺, NaCl |
| RAD8 | TGG AGT CTG CGC GAG TCA GCG CTC AAG ATC | CONTROL | |
| RAD9 | CTC TCT CTT TTT CTC TCT CTT TTT GAG AGA G | YYR triplex | Mg²⁺, NaCl |
| RAD10 | TGG GCC GGT AAC GGG TTA CCG TAA GGT CCC | 3 way junction/ | Mg²⁺, KCl, LiCl |
| | | quadruplex | |
| RAD11 | TGG GCC GGT AAC GGA TTA CCG TAA GGT CCC | 3 way junction/ | Mg²⁺, KCl, LiCl |
| | | quadruplex | |
| RAD12 | TTT TCG CGT GTG TGC GCG AA | self-complementary | Mg²⁺, NaCl |
| RAD13 | GGTTGGTTTGGTTGG | Quadruplex | KCl, LiCl |
| RAD15 | TTT TCG CGC GTA CGC GCG CGA A | self-complementary | Mg²⁺, NaCl |
| RAD16 | TTT TCG CGC GTT AAC GCG CGA A | self-complementary | Mg²⁺, NaCl |
| RAD19 | TTT IGT TGG TTT GIT TGG | Quadruplex | KCl, LiCl |
| RAD20 | CCT CTT CTT TTT CTT CTC | C-rich | pH, NaCl |
| | | protonatable | |
| RAD22 | CGCGAAAACGCG | Hairpin | temperature |
| RAD23 | CCT TCC TTT GGA AGG TTG | YR hairpin | temperature |

For each binding determination, 100 nM of oligonucleotide was mixed with 200 nM of protein, and the resultant solution was filtered. The oligonucleotide concentration in the flow-through was used to define the free ligand concentration based on standard linear curves. Each individual data point was the result of 12 measurements: three free ligand concentrations and one data point. The fluorescence in the absence of DNA was determined separately by an average of three additional measurements. The fraction of bound ligand was defined as the free ligand concentration divided by the total ligand concentration (in this case, 100 nM). In the initial studies with this assay using human IgG, determinations were made on a set of 19 ligands, shown in Table 3. For the studies with additional IgGs and IgG fragments, determinations were made on a subset of 11 of these ligands. These 11 ligands are underlined in Table 3. The data were analyzed as described above to obtain binding constants. The base 10 logarithms of these binding constants are given in Table 4 for polyclonal human IgG at two different salt concentrations and four different pH values. These results were obtained at 0.25 SSC (41 mM Na⁺) and at 0.5 SSC (82.5 mM Na⁺).

TABLE 4
Screening results expressed as logKa for binding of the
various oligonucleotides to polyclonal human IgG at two
different salt concentrations and four different pHs.

| | 41 mM Na⁺ | | | 82.5 mM Na⁺ | | | | |
|---|---|---|---|---|---|---|---|---|
| name | pH 5 | pH 6 | pH 7 | pH 8 | pH 5 | pH 6 | pH 7 | pH 8 |
| RAD 1 | 7.45 | 6.51 | 6.49 | 6.30 | 6.37 | 5.36 | 6.04 | 5.29 |
| RAD 2 | 8.74 | 7.61 | 6.96 | 6.57 | 7.04 | 6.28 | 6.23 | 5.75 |
| RAD 3 | 8.60 | 7.79 | 6.86 | 6.76 | 7.61 | 6.59 | 6.32 | 5.81 |
| RAD 4 | 8.48 | 8.13 | 7.10 | 7.02 | 7.77 | 6.78 | 6.26 | 5.77 |
| RAD 5 | 8.75 | 8.03 | 7.11 | 6.81 | 7.71 | 6.69 | 6.26 | 5.80 |
| RAD 6 | 8.50 | 7.96 | 6.86 | 6.74 | 7.43 | 6.48 | 6.12 | 5.92 |
| RAD 7 | 8.51 | 8.04 | 6.97 | 6.79 | 7.50 | 6.46 | 6.26 | 5.29 |
| RAD 8 | 8.41 | 7.85 | 6.86 | 6.84 | 7.24 | 6.33 | 6.07 | 5.48 |
| RAD 9 | 8.67 | 7.74 | 7.04 | 6.94 | 7.26 | 6.32 | 6.21 | 5.86 |
| RAD 10 | 8.41 | 7.65 | 6.81 | 6.72 | 7.04 | 6.39 | 6.10 | 5.79 |
| RAD 11 | 8.31 | 7.64 | 6.85 | 6.85 | 7.06 | 6.29 | 6.17 | 5.70 |
| RAD 12 | 7.61 | 6.98 | 6.37 | 5.74 | 6.82 | 6.19 | 5.48 | 6.12 |
| RAD 13 | 7.55 | 6.96 | 6.46 | 6.53 | 7.27 | 6.48 | 6.20 | 5.67 |
| RAD 15 | 7.65 | 7.00 | 6.33 | 6.19 | 6.80 | 6.06 | 6.23 | 6.25 |
| RAD 16 | 8.22 | 7.80 | 7.25 | 6.79 | 7.73 | 6.99 | 6.59 | 6.55 |
| RAD 19 | 7.82 | 7.14 | 6.50 | 6.04 | 7.17 | 6.19 | 5.84 | 6.03 |
| RAD 20 | 8.11 | 7.98 | 7.40 | 6.64 | 7.85 | 6.33 | 6.17 | 6.22 |
| RAD 22 | 5.95 | 6.25 | 6.04 | 5.97 | 5.42 | 5.63 | 5.79 | 5.98 |
| RAD 23 | 7.37 | 6.88 | 6.31 | 6.21 | 6.41 | 6.21 | 6.10 | 6.15 |

Shown in Table 5 are the base 10 logarithms of the binding constants vs. pH for binding by the 11 chosen ligands at 41 mM Na⁺ to polyclonal mouse IgG, the Fc and Fab2 fragments of human IgG, the Fab2 fragment of mouse IgG, human IgM, human IgA and human subtypes IgG1, IgG2, IgG3 and IgG4.

TABLE 5
Screening results expressed as logKa for binding to various human and mouse
Immunoglobulins.
Solution conditions are 37.5 mM NaCl, 3.75 mM sodium sitrate, pH 6.0.

| | Mouse | Human | Human | Mouse | Human | Human | Human | Human | Human | Human |
|---|---|---|---|---|---|---|---|---|---|---|
| | IgG | Fc | Fab2 | Fab2 | IgA | IgM | IgG1 | IgG2 | IgG3 | IgG4 |
| RAD 1 | 6.60 | 5.80 | 5.82 | 6.38 | 6.37 | 6.32 | 6.38 | 6.51 | 6.17 | 6.37 |
| RAD 2 | 7.49 | 5.86 | 6.45 | 6.71 | 6.90 | 6.73 | 7.04 | 7.06 | 6.64 | 7.08 |
| RAD 3 | 7.69 | 6.34 | 6.97 | 7.09 | 7.38 | 6.71 | 7.45 | 7.36 | 6.69 | 7.20 |
| RAD 4 | 7.71 | 5.26 | 6.89 | 7.09 | 7.66 | 6.89 | 7.52 | 7.67 | 6.66 | 7.13 |
| RAD 7 | 7.69 | 5.99 | 6.68 | 6.97 | 7.33 | 6.89 | 7.30 | 7.25 | 6.74 | 7.16 |
| RAD 9 | 7.46 | 5.87 | 6.44 | 6.75 | 6.95 | 6.79 | 7.05 | 7.05 | 6.62 | 7.06 |
| RAD 10 | 7.53 | 5.92 | 6.43 | 6.76 | 6.92 | 6.70 | 7.04 | 7.01 | 6.62 | 7.00 |
| RAD 15 | 6.35 | negl | 5.33 | 6.21 | 6.23 | 6.19 | 6.39 | 6.18 | 6.22 | 6.13 |
| RAD 16 | 7.07 | negl | 6.23 | 6.11 | 6.46 | 6.26 | 6.87 | 6.11 | 6.31 | 6.54 |
| RAD 20 | 8.30 | 5.96 | 6.90 | 7.41 | 7.53 | 7.02 | 7.34 | 7.85 | 6.84 | 7.67 |
| RAD 23 | 6.77 | negl | 5.64 | 6.33 | 6.38 | 6.08 | 6.14 | 6.86 | 5.62 | 5.97 |

Salt and pH dependences. The screening assay described here was sensitive and reproducible. Clear differences were discerned among oligonucleotides with respect to their binding to individual immunoglobulins. Differences were also apparent in how individual oligonucleotides bind to different immunoglobulins. The behaviors of the different oligonucleotides with respect to pH-dependent binding showed both quantitative and qualitative differences. Certain oligonucleotides such as RAD20 were seen to be excellent binders to a variety of IgGs and to IgA and IgM, at least under the relatively low salt conditions of these comparative experiments (41 mM Na⁺). Whereas all oligonucleotides showed decreased binding at higher salt, oligonucleotides such as RAD16 showed a reduced salt-dependence compared to others. A characteristic decrease in binding affinity with increased salt concentration is generally observed for DNA-protein interactions, whether specific or nonspecific, and is understood to reflect the entropic consequences of the release of bound cations upon DNA-protein complex formation. It is important to realize that a salt-dependence per se by no means suggests that binding occurs by a nonspecific ion-exchange mechanism. The fact that a wide variation of binding strength is observed among oligonucleotides for binding to a particular type of IgG, IgA or IgM and that the ordering of oligonucleotide binding depends on the nature of the immunoglobulin further demonstrates specific interactions with specific immunoglobulin surface features. In general, a decrease in binding constant is anticipated as the pH is increased. This effect is anticipated even for highly specific binding interactions, as long as ionic interactions occur between negatively charged groups on the DNA and positively charged groups on the protein. However, the pH effect is less uniform than the salt effect and can reflect protonation events near the binding site on both the protein and on the DNA. For DNA, cytosine bases can protonate and allow the formation of fold-back and tetraplex structures around neutral pH, which can significantly affect the pH-dependent binding curves. It is notable that there are a number of situations where the fraction of bound ligand does not change greatly between pH 6 and 7 and even a few cases where the binding of individual oligonucleotides appears to increase on going from pH 6 to pH 7.

Location of the multistate affinity ligand binding sites. Binding to the Fc fragment was significant only at the lowest pH examined. In contrast, both the human and the mouse Fab2 fragments showed binding that is comparable to that observed for whole IgG as well as similar dependences on multistate affinity ligand type and on pH. Based on these results, it seems likely that the polyanion binding sites on IgG that were recognized by the multistate affinity ligands were primarily located on the Fab2 fragment.

Binding to human IgG subtypes. As can be discerned from the results shown, the protein subtype that binds most tightly to a number of the multistate affinity ligands was, in fact, subtype IgG2. In contrast, IgG2 scarcely binds to Protein A, which places significant limitations on the purification of IgG2 subtypes. The other subtypes likewise bound tightly to several of the multistate affinity ligands, although the ordering of multistate affinity ligand binding did not appear to depend on the IgG subtype examined.

Binding to IgA and IgM. IgA bound very tightly to RAD4, RAD20, RAD3 and RAD23. The binding of IgM showed a lower level of discrimination among the tightest binding multistate affinity ligands under the solution conditions studied, although this discrimination may be enhanced by variations in binding and elution conditions.

### Example 10

### Screening of Multistate Affinity Ligands for Binding to Immunoglobulins

100 to 150 nanomoles of amino-linked TAL was reacted with 300 uL of NHS-activated Sepharose according to the manufacturer's procedure. After overnight coupling, unreacted sites on the Sepharose were deactivated by reaction with 0.5 M ethanolamine. OD measurements after removing the released NHS (which interferes with the OD measurements) by gel filtration indicated TAL substitution to the Sepharose was between 120 nanomoles (RAD 4) to 70 nanomoles (RAD 16), meaning a degree of substitution on the TAL-Sepharose of approximately 0.3 micromole/ml of gel. The TAL-Sepharose was divided equally between three Costar centrifuge tubes with wells containing 22 micron filters (approx. 100 microliters Sepharose per well). The gel in each tube was equilibrated with the appropriate buffer by addition of multiple washes with buffer followed by spinning the buffer through the gel (which was retained on the filter in the wells). Two microliters of fluorescein-labeled IgG (Jackson ImmunoResearch Laboratories, West Grove, Pa.) at a concentration of 2 mg/ml in a solution containing BSA (15 mg/ml) was added to 200 microliters of the appropriate buffer solution, and the reaction mixture was then added to the gel-containing wells. The gel and IgG were mixed on a shaker for 1 hour, and the solution was recovered by spinning it through the gel. Solution fluorescence was measured in a fluorescence plate counter (where low readings in the filtrate indicate binding to the TAL-Sepharose). A blank was done by filtering the same solution through a filter well with no gel. Results are presented in Table 6 below for the following buffers: 0.0067M phosphate, pH 7.4 with 0.15M NaCl (PBS); 0.067 M phosphate, pH 7.4 with 1.5M NaCl (10×PBS); and 0.020M MES pH5.8 (MES).

TABLE 6
Binding of fluorescein-labeled human IgG to immobilized TALs
under varying buffer conditions (expressed as counts per second
(where binding is indicated by subtracting counts from blank).

| TAL | Blank (no gel) | PBS | 10xPBS | MES |
|---|---|---|---|---|
| RAD4 | 26,000 | 25,000 | 15,500 | 1,300 |
| RAD9 | 26,000 | 17,700 | 13,200 | 2,000 |
| RAD10 | 24,200 | 11,500 | 8,600 | 1,200 |
| RAD16 | 24,200 | 13,500 | 7,800 | 870 |
| RAD20 | 24.300 | 14,800 | 9,800 | 1.560 |

For the purposes of clarity and understanding, the present invention has been described in the foregoing examples and disclosure. It will be apparent, however, that certain changes and modifications mat be practiced within the scope of the appended claims.

We claim:

1. A medium for purifying a target molecule selected from the group consisting of antibodies, antibody fragments and conjugates thereof, said medium comprising a nucleotide-containing multistate affinity ligand immobilized on a matrix, said multistate affinity ligand existing in a first state having a defined first affinity for the target molecule in a first buffer and a second state having a defined second affinity for the target molecule in a second buffer wherein the ratio of the defined first affinity to the defined second affinity is at least two.

2. The medium of claim 1 wherein the ratio of the defined first affinity to the defined second affinity is at least 10.

3. The medium of claim 1 wherein the ratio of the defined first affinity to the defined second affinity is at least 100.

4. The medium of claim 1 wherein the ratio of the defined first affinity to the defined second affinity is at least 1000.

5. The medium of claim 1 wherein the first state of the multistate affinity ligand favors association of ligand-target complexes and the second state of the multistate affinity ligand favors dissociation of ligand-target complexes at target concentrations greater than 10 nanomolar.

6. The medium of claim 1 wherein the first state of the multistate affinity ligand favors association of ligand-target complexes and the second state of the multistate affinity ligand favors dissociation of ligand-target complexes at target concentrations greater than one nanomolar.

7. The medium of claim 1 wherein the first state of the multistate affinity ligand favors association of ligand-target complexes and the second state of the multistate affinity ligand favors dissociation of ligand-target complexes at target concentrations less than one nanomolar.

8. The medium of claim 1 wherein the matrix comprises a solid, semisolid, insoluble, insolubilized or precipitable porous or nonporous support, polymer, glass, gel, bead, resin, colloid, membrane, filter, microparticle, microorganism, nanoparticle, macromolecule or complex.

9. The medium of claim 1 wherein the multistate affinity ligand comprises a nonnaturally occurring polymer.

10. The medium of claim 1 wherein the multistate affinity ligand is prepared at least in part by solid phase synthesis.

11. The medium of claim 1 wherein the multistate affinity ligand exists in a dynamic equilibrium between the first state and the second state.

12. The medium of claim 1 wherein the first state and the second state are conformationally distinct states that can be distinguished by at least one of a physical, spectroscopic, hydrodynamic, calorimetric, thermodynamic, electrophoretic, chromatographic or computational technique.

13. The medium of claim 1 wherein the first affinity for the target molecule in the first buffer depends on the presence or amount of at least one nontarget substance selected from the group consisting of salts, sugars, ions, zwitterions, chelating agents, proteins, peptides, lipids, detergents, oxidizing agents, reducing agents, solvents, solutes, nucleotides, catalysts, coenzymes, cofactors, intercalating agents and dyes.

14. The medium of claim 1 wherein the second affinity for the target molecule in the second buffer depends on the presence or amount of at least one nontarget substance selected from the group consisting of salts, sugars, ions, zwitterions, chelating agents, proteins, peptides, lipids, detergents, oxidizing agents, reducing agents, solvents, solutes, nucleotides, catalysts, coenzymes, cofactors, intercalating agents and dyes.

15. The medium of claim 1 wherein the second state of the multistate affinity ligand is topologically different from the first state.

16. The medium of claim 1 wherein the multistate affinity ligand is designed or selected to bind immunoglobulin subtypes with broader class specificity than Protein A or Protein G.

17. The medium of claim 1 wherein the multistate affinity ligand is designed or selected to bind immunoglobulin subtypes with greater selectivity than Protein A or Protein G.

18. A preparative device for isolating target molecules from a sample, said target molecules being selected from the group consisting of antibodies, antibody fragments and conjugates thereof, said device comprising:
a) a nucleotide-containing multistate affinity ligand;
b) means for delivering the sample to the multistate affinity ligand to form a reaction mixture in which the multistate affinity ligand exists in a target-binding state;
c) means for partitioning ligand-target complexes from other substances in the reaction mixture;
d) means for converting the multistate affinity ligand from a target-binding state to a target-nonbinding state; and
e) means for partitioning unbound target molecules from ligand-bound target molecules.

19. A kit for the purification of an antibody, antibody fragment or conjugate thereof comprising a buffer-responsive multistate affinity ligand, a binding buffer and a releasing buffer wherein the multistate affinity ligand comprises a nucleotide-containing polymer that switches between an immunoglobulin-binding state in the presence of the binding buffer and an immunoglobulin-nonbinding state in the presence of the releasing buffer.

20. A system for purifying from a sample a target molecule selected from the group consisting of antibodies, antibody fragments and conjugates thereof comprising:
a) a processing reservoir containing a separation reagent;
b) input means for delivering substances to the processing reservoir;
c) output means for removing substances from the processing reservoir;
d) a first buffer solution; and
e) a second buffer solution;
wherein the separation reagent is a nucleotide-containing multistate affinity ligand that exists in a first state with a relatively high affinity for the target molecule in the presence of the first buffer solution and a second state with a relatively low affinity for the target molecule in the presence of the second buffer solution.

21. A method of purifying an antigen-binding target molecule from a sample containing the target molecule comprising:
a) contacting the sample with an environmentally-sensitive multistate affinity ligand under a first environmental condition;
b) partitioning the ligand-target complex from nontarget substances in the sample; and
c) releasing the target from the ligand-target complex by exposing the complex to a second environmental condition
wherein
i) the target molecule is selected from the group consisting of antibodies, antibody fragments and conjugates thereof;
ii) the antigen-binding properties of the target molecule remain intact following exposure to the first environmental condition and the second environmental condition; and
iii) the multistate affinity ligand comprises a nucleotide-containing polymer that reversibly partitions between a first state having a first affinity for the target molecule under the first environmental condition and a second state having a second affinity for the target molecule under the second environmental condition.

22. The method of claim 21 wherein the first state of the multistate affinity ligand specifically binds the antigen-binding target molecule with an affinity that depends on at least one of the structural integrity or the antigen-binding function of the target molecule.

23. The method of claim 21 wherein the multistate ligand is selected or designed to competitively inhibit the binding of the target molecule to its cognate antigen.

24. The method of claim 21 wherein the multistate ligand is selected or designed to specifically bind the target molecule in a manner that is noncompetitive with the binding of the target molecule to its cognate antigen.

25. The method of claim 21 wherein the multistate affinity ligand is antiidiotypic to the antigen-binding target molecule.

26. A method of separating a first molecule comprising an antibody, antibody fragment or conjugate thereof from a second molecule comprising:
a) contacting a sample containing the first molecule and the second molecule with a nucleotide-containing immobilized multistate affinity ligand in a first buffer solution having a composition in which the multistate affinity ligand exists in a first state that specifically binds the first molecule with relatively high affinity;
b) incubating the sample with the immobilized multistate affinity ligand for a sufficient contact time to allow the immobilized multistate affinity ligand to bind the first molecule to form an immobilized ligand-first molecule complex;
c) partitioning the second molecule from the immobilized ligand-first molecule complex;
d) exposing the immobilized ligand-first molecule complex to a second buffer solution having a composition in which the immobilized multistate affinity ligand has a relatively low affinity for the first molecule; and
e) partitioning the first molecule from the immobilized multistate affinity ligand.

27. A method of making an antibody purification product comprising immobilizing a multistate affinity ligand on an insoluble matrix and packaging the immobilized multistate affinity ligand in a sealed or sealable container, said multistate affinity ligand comprising a nucleotide-containing polymer that specifically binds in a first buffer to an antigen-binding target molecule selected from the group consisting of antibodies, antibody fragments and conjugates thereof to form an immobilized multistate affinity ligand-target complex that dissociates in a second buffer to yield ligand-free target molecule.

28. The method of claim 27 wherein the multistate affinity ligand specifically binds the antigen-binding target molecule with an affinity that depends on at least one of the structural integrity or the antigen-binding function of the target molecule.

29. The method of claim 27 wherein multistate affinity ligand binds the antigen-binding target molecule with a specificity that distinguishes target molecules based upon at least one of their antigen-binding affinity or specificity.

30. The method of claim 27 wherein the multistate ligand is selected or designed to competitively inhibit the binding of the target molecule to its cognate antigen.

31. The method of claim 27 wherein the multistate ligand is selected or designed to specifically bind the target molecule in a manner that is noncompetitive with the binding of the target molecule to its cognate antigen.

32. The method of claim 27 wherein the multistate affinity ligand is antiidiotypic to the antigen-binding target molecule.

33. A method of separating a first molecule or group of molecules selected from the group consisting of antibodies, antibody fragments and conjugates thereof from a second molecule comprising the steps of:
a) contacting a sample containing the first molecule or group of molecules and the second molecule with a nucleotide-containing multistate affinity ligand immobilized on a solid support immersed in a binding buffer;
b) incubating the sample with the immobilized multistate affinity ligand for a sufficient contact time to allow the immobilized multistate affinity ligand to bind the first molecule or group of molecules to form an immobilized ligand-molecule complex;
c) performing a rinsing step to remove the second molecule;
d) performing at least one elution step to dissociate the first molecule or group of molecules from the ligand of the immobilized ligand-molecule complex; and
e) collecting at least one product of the at least one elution step;
wherein said at least one elution step causes the multistate affinity ligand to shift from a first conformational equilibrium state that favors association of immobilized ligand-molecule complexes to a second conformational equilibrium state that favors dissociation of immobilized ligand-molecule complexes.

34. The method of claim 33 further rinsing the solid support with a cleaning buffer.

35. The method of claim 33 further comprising rinsing the solid support with a buffer that restores the multistate affinity ligand to the first conformational equilibrium state.

36. The method of claim 33 further comprising rinsing the solid support in a storage buffer.

37. The method of claim 33 further comprising a subfractionation step using at least one of Protein A or Protein G to remove an immunoglobulin species.

38. The method of claim 33 wherein the at least one elution step includes elution with a plurality of buffers or a buffer gradient to cause the multistate affinity ligand to shift from the first conformational equilibrium state to the second conformational equilibrium state

39. The method of claim 33 wherein the first molecule or group of molecule comprises an immunoglobulin of class A, D, E, G, M or Y.

40. The method of claim 33 wherein the first molecule or group of molecules comprises an immunoglobulin of subclass or subtype IgA1, IgA2, IgG1, IgG2, IgG2a, IgG2b, IgG2c, IgG3, IgG4, IgM, IgN, IgR, IgW, IgX or IgY.

41. The method of claim 33 wherein the first molecule or group of molecules comprises an immunoglobulin originating from a species selected from the group consisting of mouse, rat, rabbit, goat, sheep, horse, pig, chicken, human, monkey, dog, chimpanzee, cow, guinea pig and cat.

42. The method of claim 33 wherein the first molecule or group of molecules comprises an immunoglobulin fragment selected from the group consisting of Fab, F(ab′), F(ab′)2 and Fc fragments.

43. The method of claim 33 wherein the second molecule is selected from the group consisting of serum- and cell culture-derived constituents and nutrients, growth factors, hormones, supplements, proteins, immunoglobulins, lipids, antibodies, antibody fragments and conjugates.

44. The method of claim 33 wherein the first molecule or group of molecules includes a conjugate and the second molecule is a conjugate.

45. The method of claim 33 wherein the first molecule or group of molecules includes an antibody or antibody fragment and the second molecule is an antibody or antibody fragment.

46. The method of claim 33 wherein the at least one product of the at least one elution step contains a single class of immunoglobulin.

47. The method of claim 33 wherein the at least one product of the at least one elution step contains a single subclass or subtype of immunoglobulin.

48. The method of claim 33 wherein the at least one product of the at least one elution step contains immunoglobulins having at least two different subtypes selected from the group consisting of IgG1, IgG2, IgG2a, IgG2b, IgG3 and IgG4.

49. The method of claim 33 wherein the at least one product of the at least one elution step contains immunoglobulins having at least three different subtypes selected from the group consisting of IgG1, IgG2, IgG2a, IgG2b, IgG3 and IgG4.

50. The method of claim 33 wherein the at least one product of the at least one elution step contains immunoglobulins of subtypes IgG1, IgG2, IgG2a, IgG2b, IgG3 and IgG4.

51. The method of claim 33 wherein the first state of the multistate affinity ligand specifically binds immunoglobulin molecules in a subtype-specific or subtype-selective manner.

52. The method of claim 33 wherein the first state of the multistate affinity ligand specifically binds immunoglobulin molecules in a subtype-independent manner

53. The method of claim 33 wherein the first state of the multistate affinity ligand binds human IgG3 molecules with relatively high affinity.

54. A medium for purifying target molecules selected from the group consisting of antibodies, antibody fragments and conjugates thereof, said medium comprising a support-bound plurality of ligands, said plurality of ligands including at least one multistate affinity ligand existing in a first state having a defined first affinity for a target molecule in a first buffer and a second state having a defined second affinity for the target molecule in a second buffer wherein the ratio of the defined first affinity to the defined second affinity is at least two.

55. The medium of claim 54 wherein the plurality of ligands includes ligands having different affinities for the target molecule.

56. The medium of claim 54 wherein the plurality of ligands includes ligands having different specificities for the target molecule.

57. The medium of claim 54 wherein the plurality of ligands includes ligands that specifically bind different target molecules.

58. A method of making an antibody purification product comprising preparing a support-bound plurality of, ligands including at least one multistate affinity ligand and packaging the support-bound plurality of ligands in a sealed or sealable container, said plurality of ligands including at least one multistate affinity ligand comprising a nucleotide-containing polymer that specifically binds in a first buffer to antigen-binding target molecules selected from the group consisting of antibodies, antibody fragments and conjugates thereof to form support-bound multistate affinity ligand-target complexes that dissociate in a second buffer to yield ligand-free target molecules.

59. The method of claim 58 wherein the plurality of ligands includes ligands having different affinities for the target molecules.

60. The method of claim 58 wherein the plurality of ligands includes ligands having different specificities for the target molecules.

61. The method of claim 58 wherein the plurality of ligands includes ligands that specifically bind different target molecules.
